(19) United States
(12) Patent Application Publication
(10) Pub. No.: US 2026/0172084 A1
(43) Pub. Date: Jun. 18, 2026

(54) POLICY UPDATES FOR ANTENNA SELECTION

(71) Applicant: QUALCOMM Incorporated, San Diego, CA (US)

(72) Inventors: Hyojin LEE, San Diego, CA (US); Akash Sandeep DOSHI, San Diego, CA (US); June NAMGOONG, San Diego, CA (US); Yu ZHANG, San Diego, CA (US); Jing JIANG, San Diego, CA (US); Danlu ZHANG, San Diego, CA (US)

(21) Appl. No.: 18/981,133

(22) Filed: Dec. 13, 2024

(51) Int. Cl. H04B 7/06; H04W 24/10

(52) U.S. Cl. CPC H04B 7/061; H04W 24/10

(57) ABSTRACT

Various aspects of the present disclosure generally relate to wireless communication. In some aspects, a first network entity may select, in accordance with a first antenna selection policy, one or more first antennas. The first network entity may transmit, using the one or more first antennas, one or more first signals. The first network entity may obtain, based on the one or more first signals, feedback information indicative of a first performance level of the one or more first antennas. The first network entity may select, in accordance with a second antenna selection policy, one or more second antennas, wherein the second antenna selection policy is based on the feedback information. The first network entity may transmit, using the one or more second antennas, one or more second signals. Numerous other aspects are described.

### FIELD OF THE DISCLOSURE

Aspects of the present disclosure generally relate to wireless communication and specifically relate to techniques, apparatuses, and methods associated with policy updates for antenna selection.

### INTRODUCTION

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

Some applications and techniques for wireless communication may be implemented, at least in part, using an artificial intelligence (AI) program (for example, referred to herein as an “AI/ML model”), such as a program that includes a machine learning (ML) model and/or an artificial neural network (ANN) model. The AI/ML model(s) may be configured to enhance various aspects of the wireless communication network (for example, to increase privacy, reliability, and/or efficient use of network bandwidth, and/or to reduce latency, among other examples). For example, the AI/ML model(s) may be trained to identify patterns or relationships in data corresponding to the wireless communication network, a device, and/or an air interface, among other examples. The AI/ML model(s) may support operational decisions relating to one or more applications and techniques associated with wireless communications devices, networks, and/or or services, among other examples.

### SUMMARY

In some aspects, a first network entity includes a processing system configured to: select, in accordance with a first antenna selection policy, one or more first antennas; transmit, using the one or more first antennas, one or more first signals; obtain, based on the one or more first signals, feedback information indicative of a first performance level of the one or more first antennas; select, in accordance with a second antenna selection policy, one or more second antennas, wherein the second antenna selection policy is based on the feedback information; and transmit, using the one or more second antennas, one or more second signals.

In some aspects, a first network entity includes a processing system configured to: receive one or more signals indicative of an antenna selection result associated with an antenna selection policy of a second network entity; and transmit, based on the one or more signals, feedback information indicative of a first performance level of the antenna selection result.

In some aspects, a method of wireless communication performed by a first network entity includes selecting, in accordance with a first antenna selection policy, one or more first antennas; transmitting, using the one or more first antennas, one or more first signals; obtaining, based on the one or more first signals, feedback information indicative of a first performance level of the one or more first antennas; selecting, in accordance with a second antenna selection policy, one or more second antennas, wherein the second antenna selection policy is based on the feedback information; and transmitting, using the one or more second antennas, one or more second signals.

In some aspects, a method of wireless communication performed by a first network entity includes receiving one or more signals indicative of an antenna selection result associated with an antenna selection policy of a second network entity; and transmitting, based on the one or more signals, feedback information indicative of a first performance level of the antenna selection result.

In some aspects, a non-transitory computer-readable medium has code stored thereon that, when executed by a first network entity, causes the first network entity to: select, in accordance with a first antenna selection policy, one or more first antennas; transmit, using the one or more first antennas, one or more first signals; obtain, based on the one or more first signals, feedback information indicative of a first performance level of the one or more first antennas; select, in accordance with a second antenna selection policy, one or more second antennas, wherein the second antenna selection policy is based on the feedback information; and transmit, using the one or more second antennas, one or more second signals.

In some aspects, a non-transitory computer-readable medium has code stored thereon that, when executed by a first network entity, causes the first network entity to: receive one or more signals indicative of an antenna selection result associated with an antenna selection policy of a second network entity; and transmit, based on the one or more signals, feedback information indicative of a first performance level of the antenna selection result.

In some aspects, an apparatus for wireless communication includes means for selecting, in accordance with a first antenna selection policy, one or more first antennas; means for transmitting, using the one or more first antennas, one or more first signals; means for obtaining, based on the one or more first signals, feedback information indicative of a first performance level of the one or more first antennas; means for selecting, in accordance with a second antenna selection policy, one or more second antennas, wherein the second antenna selection policy is based on the feedback information; and means for transmitting, using the one or more second antennas, one or more second signals.

In some aspects, a first apparatus for wireless communication includes means for receiving one or more signals indicative of an antenna selection result associated with an antenna selection policy of a second apparatus; and means for transmitting, based on the one or more signals, feedback information indicative of a first performance level of the antenna selection result.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing broadly outlines example features and example technical advantages of examples according to the disclosure. Additional example features and example advantages are described hereinafter.

### BRIEF DESCRIPTION OF THE DRAWINGS

The appended drawings illustrate certain example aspects of this disclosure and are therefore not limiting in scope. The same reference numbers in different drawings may identify the same or similar elements.

FIG. 1 is a diagram illustrating an example environment in which apparatuses and/or methods described herein may be implemented, in accordance with the present disclosure.

FIG. 2 is a diagram illustrating an example of a wireless communication network, in accordance with the present disclosure.

FIG. 3 is a diagram illustrating an example disaggregated network node architecture, in accordance with the present disclosure.

FIG. 4 is a diagram illustrating an example artificial intelligence and/or machine learning model, in accordance with the present disclosure.

FIG. 5 is a diagram illustrating an example architecture of a functional framework for radio access network intelligence enabled by data collection, in accordance with the present disclosure.

FIG. 6 is a diagram illustrating an example of antenna selection, in accordance with the present disclosure.

FIG. 7 is a diagram of an example associated with policy updates for antenna selection, in accordance with the present disclosure.

FIG. 8 is a diagram of an example associated with policy updates for antenna selection, in accordance with the present disclosure.

FIG. 9 is a diagram of an example associated with a model architecture for antenna selection, in accordance with the present disclosure.

FIG. 10 is a diagram illustrating an example process performed, for example, at a first network entity or an apparatus of a first network entity, in accordance with the present disclosure.

FIG. 11 is a diagram illustrating an example process performed, for example, at a first network entity or an apparatus of a first network entity, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. The scope of the disclosure covers any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure covers an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

The evolution of wireless communications has consistently involved adaptation and enhancement of radio access network (RAN) technologies to support increased data rates, reduced latency, and improved reliability for an air interface, among other examples. An important issue with these advancements includes optimizing beam management to ensure efficient and robust communication between a UE and a network node, particularly involving MIMO systems that leverage antenna arrays that may include numerous transmit antennas and/or receive antennas. Antenna management is important in order to maintain signal quality and ensure efficient utilization of radio spectrum by selecting and activating appropriate beams that are used to focus or direct signals toward the UE. Antenna management tasks become more complex with more advanced technologies and higher frequency bands, such as millimeter wave (mmWave) frequency bands (e.g., FR2 or FR4), where beamforming is a technique used to overcome propagation challenges (e.g., path loss).

A network entity, such as a network node or a user equipment (UE), may include fewer transmit chains than antennas. The network entity may also include a capability to switch connections between a transmit chain and an antenna. For instance, the network entity may decouple a transmit chain from a first antenna and couple the transmit chain to a second antenna. The ability for a network entity to switch and/or change connections between transmit chains and antennas may enable the network entity to dynamically select and/or switch an antenna configuration (e.g., one or more antennas out of a set of antennas) that results in a higher signal quality relative to using a different antenna configuration. Examples of a higher signal quality may include a first signal with a higher signal power level, a lower interference level, and/or a higher signal-to-noise ratio (SNR) relative to a second signal. To determine a best antenna configuration out of a set of antennas, the network entity may use and/or analyze a variety of factors, such as a per-antenna transmit power budget and/or one or more propagation channel characteristics of a channel between a transmitting network entity and a receiving network entity (e.g., a UE and a network node, respectively, for an uplink channel).

A UE may perform uplink antenna selection in an open-loop manner that is transparent to a network node. For example, the UE may determine one or more measurement values based at least in part on receiving one or more downlink signals, generating a measurement metric using each downlink signal/antenna combination, and comparing the measurement metrics to determine which antenna and/or antenna configuration is linked to a higher signal quality. Based on an assumption that at least some reciprocity exists between a downlink channel and an uplink channel, the UE may select an uplink antenna configuration using the antenna that produces a higher signal quality for a downlink signal. However, reciprocity between the uplink channel and the downlink channel may not exist, resulting in the UE selecting an antenna configuration that is sub-optimal and/or produces a decreased signal quality (e.g., reduced signal power level and/or reduced SNR). The decreased signal quality may lead to increased recovery errors, increased data transfer delays, and/or decreased data throughput in a wireless communication network, among other examples.

Closed-loop antenna selection (CLAS) may include a network node selecting an uplink antenna configuration for a UE based at least in part on uplink signaling between a UE and a network node. For instance, the network node may select an uplink antenna configuration by reusing an uplink multiple-input multiple output (MIMO) architecture that uses codebook-based (CB) uplink MIMO signaling and/or non-codebook-based (NCB) uplink MIMO signaling. However, a network node reusing an uplink MIMO architecture and uplink MIMO signaling (e.g., CB uplink MIMO signaling and/or NCB uplink MIMO signaling) to perform CLAS may lack flexibility and/or support for various chain-antenna structures. For example, uplink MIMO architecture in combination with CB uplink MIMO signaling for uplink antenna selection may only be used for antenna selection between a limited number of connections, each of which uses a separate reference signal resource (e.g., a sounding reference signal (SRS) resource) for the antenna selection, and the uplink MIMO architecture in combination with NCB uplink MIMO signaling may only allow the network node to perform an uplink antenna selection for a non-coherent antenna selection architecture and/or a fully connected antenna selection architecture, since precoding selection capability (which does not have any selection constraint) is replaced by an antenna selection capability. Additionally, or alternatively, CLAS that uses the uplink MIMO architecture and uplink MIMO signaling may only be applicable to UEs that support fast dynamic antenna switching and/or may not be applicable to UEs that do not support fast dynamic antenna switching. Accordingly, a network node reusing an uplink MIMO architecture and uplink MIMO signaling for uplink antenna selection may not be supported by a wide variety of UEs, resulting in at least some UEs using a sub-optimal uplink antenna configuration, such as an uplink antenna configuration that is based at least in part on assuming reciprocity between an uplink channel and a downlink channel.

However, CLAS may include a network node using signals (e.g., SRSs) transmitted by the UE as part of the CLAS operation (e.g., the network node may measure one or more SRSs to obtain measurement information and select an antenna configuration for the UE based on the measurement information). However, the UE may transmit the signals (e.g., SRSs) relatively infrequently (e.g., as compared to downlink reference signals from the network node). As a result, CLAS may be associated with slower antenna selection adaptation as compared to open-loop antenna selection by the UE (e.g., CLAS may increase latency associated with adapting or changing the antenna configuration of the UE because of the less frequent uplink signal transmission by the UE). The slower antenna selection adaptation may degrade performance of the UE, such as when channel conditions are changing relatively frequently.

Various aspects relate generally to policy updates for antenna selection. Some aspects more specifically relate to a network entity (e.g., a UE) using an artificial intelligence or machine learning (AI/ML) model for antenna selection (e.g., sometimes referred to as machine learning antenna selection (MLAS)). In some aspects, the network entity may select, in accordance with a first antenna selection policy, one or more first antennas. The network entity may transmit, using the one or more first antennas, one or more first signals. The network entity may obtain, based on the one or more first signals, feedback information indicative of a first performance level (e.g., an average throughput, and/or measurement information) of the one or more first antennas. The network entity may select, in accordance with a second antenna selection policy, one or more second antennas. The second antenna selection policy may be based on the feedback information. The network entity may transmit, using the one or more second antennas, one or more second signals.

As used herein, antenna selection “policy” may refer to a strategy or mapping indicative of actions to be taken by the network entity for antenna selection in a given environment based on a current state. The policy may be for an AI/ML model. For example, an antenna selection policy may refer to a strategy or a mapping that determines the actions that the AI/ML model should take in a given environment, based on current state of the AI/ML model. The antenna selection policy may be deterministic (e.g., with fixed actions for respective states) or probabilistic (e.g., in which a probability distribution indicates probabilities for respective actions for a given state). The antenna selection policy may be configured or determined to maximize a cumulative reward by guiding the decisions of the AI/ML model toward actions that yield higher long-term benefits for antenna selection, such as improved throughput and/or improved measurement information (e.g., higher measurement values), among other examples. As used herein, “reward” may refer to a scalar feedback signal that is indicative of the benefit or outcome of an antenna selection by the network entity based on the output of the AI/ML model. For example, performance level information for an antenna selection may indicate a reward (or reward information) for the antenna selection. For example, with reinforcement learning, the AI/ML model may learn from interactions with its operation/environment, such as in the form of feedback akin to rewards or penalties. Reinforcement learning may be particularly beneficial when used to improve or attempt to optimize a behavior (such as antenna selection) of the AI/ML model deployed in a dynamically changing environment, such as a wireless communication network.

The network entity (e.g., the UE) may update the antenna selection policy in an open-loop manner and/or in a closed-loop manner. The network entity (e.g., the UE) may use a direct performance optimization (DPO) technique to update the policy (e.g., to fine-tune the policy in a supervised learning manner). For example, for open-loop updating of the antenna selection policy, the feedback information may include throughput information for the one or more first antennas selected in accordance with the first antenna selection policy. If the throughput information indicates an increase in throughput, then the network entity (e.g., the UE) may update the first antenna selection policy (e.g., to obtain the second antenna selection policy) to indicate that the selection of the one or more first antennas is a correct selection (e.g., to indicate that the selection of the one or more first antennas is a positive reward for the AI/ML model). If the throughput information indicates a decrease in throughput, then the network entity (e.g., the UE) may update the first antenna selection policy (e.g., to obtain the second antenna selection policy) to indicate that the selection of the one or more first antennas is an incorrect selection (e.g., to indicate that the selection of the one or more first antennas is a negative reward for the AI/ML model). Additionally, or alternatively, for closed-loop updating of the antenna selection policy, the network entity may receive the feedback information from another network entity (e.g., a network node). In such examples, the feedback information may indicate measurement information obtained by the other network entity (e.g., the network node), one or more best antenna selection results determined by the other network entity (e.g., the network node), and/or an indication of whether a most recent antenna selection is an improvement over a previous antenna selection, among other examples. The network entity (e.g., the UE) may update the first antenna selection policy (e.g., to obtain the second antenna selection policy) to indicate whether the selection of the one or more first antennas is a correct selection or an incorrect selection based on the feedback information received from the other network entity (e.g., the network node).

Particular aspects of the subject matter described in this disclosure can be implemented to realize one or more of the following potential advantages. In some examples, the described techniques can be used to improve antenna selection by the network entity (e.g., by the UE). For example, by the network entity (e.g., the UE) using the antenna selection policy (e.g., updated using DPO in an open-loop manner and/or a closed-loop manner), the network entity may select one or more antennas for use by the network entity that result in improved performance (e.g., improved throughput, improved signal strength, and/or improved signal quality). For example, by the network entity (e.g., the UE) updating the antenna selection policy in the open-loop manner described herein, the network entity may reduce the latency associated with updating the antenna selection policy because the feedback information may be more frequently available at the network entity. This may enable fast antenna selection adaptation. Additionally, by the network entity (e.g., the UE) updating the antenna selection policy in the open-loop manner described herein, the network entity may mitigate the effects of channel reciprocity error in the antenna selection by using the feedback information received from another network entity (e.g., a network node). As a result, the network entity (e.g., the UE) may use MLAS to select one or more antennas based on downlink measurement information (e.g., to enable fast antenna selection adaptation) while the antenna selection policy can be updated (e.g., fine-tuned in a reinforcement learning manner) based on uplink-based feedback received from another network entity (e.g., a network node) to mitigate antenna selection errors or degraded performance that would otherwise be caused by channel reciprocity errors.

Various aspects of the disclosure are described more fully hereinafter with reference to the accompanying drawings. This disclosure may, however, be embodied in many different forms and is not limited to any specific structure, function, example, aspect, or the like presented throughout this disclosure. This disclosure includes, for example, any aspect disclosed herein, whether implemented independently of or combined with any other aspect of the disclosure. For example, an apparatus may be implemented or a method may be practiced using any number of the aspects set forth herein. In addition, the scope of the disclosure includes such an apparatus or method which is practiced using other structure, functionality, or structure and functionality in addition to or other than the various aspects of the disclosure set forth herein. Any aspect of the disclosure disclosed herein may be embodied by one or more elements of a claim.

Aspects and examples generally include a method, apparatus, network node, network entity, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the example concepts disclosed herein, both their organization and method of operation, together with associated example advantages, are described in the following description and in connection with the accompanying figures. Each of the figures is provided for the purposes of illustration and description, and not as a definition of the limits of the claims. Each of the figures is provided for the purposes of illustration and description, and not as a definition of the limits of the claims.

While aspects are described in the present disclosure by illustration to some examples, those skilled in the art understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described example aspects and example features may include additional example components and example features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, RF sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

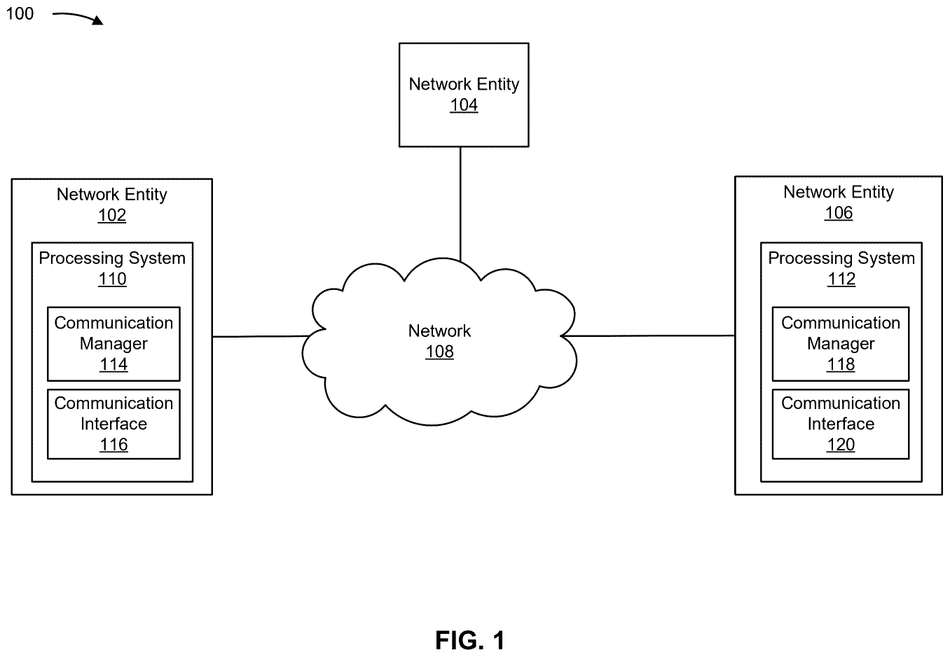

FIG. 1 is a diagram illustrating an example environment 100 in which apparatuses and/or methods described herein may be implemented, in accordance with the present disclosure. As shown in FIG. 1, the environment 100 may include a network entity 102, a network entity 104, and a network entity 106, that may communicate with one another via a network 108. The network entities 102, 104, and 106, may be dispersed throughout the network 108, and each network entity 102, 104, and 106 may be stationary and/or mobile. The network 108 may include wired communication connections, wireless communication connections, or a combination of wired and wireless communication connections.

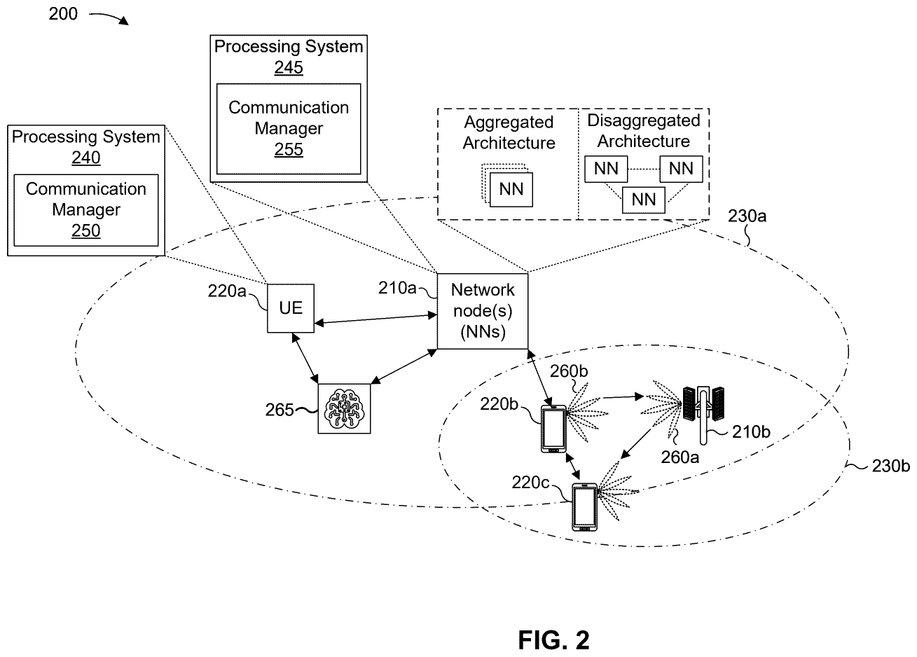

The network 108 may include, for example, a cellular network (e.g., a Long-Term Evolution (LTE) network, a CDMA network, a 4G network, a 5G network, a 6G network, or another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks. The network 108 may include a wireless communication network 200, described in connection with FIG. 2.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 108. For example, a “network entity” is not limited to an entity that is currently located in and/or currently operating in the network. Rather, a network entity may be any entity that is capable of communicating and/or operating in the network. A network entity may include a network node 210 or a UE 220, described in more detail in connection with FIG. 2.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, “first network entity” may refer to a first UE, a first base station, a first apparatus, a first device, a first computing system, a first set of one or more one or more components, a first processing entity, or the like configured to receive the information; and “second network entity” may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity 102 may include a processing system 110. Similarly, the network entity 106 may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. A processing system (which may include the processing system 110 and the processing system 112) is described in more detail in connection with FIG. 2, such as in connection with processing system 240 and processing system 245.

As described herein, an “input” and “input information” may be used interchangeably. Similarly, as described herein, an “output” and “output information” may be used interchangeably. Any information generated by any component may be provided to one or more other systems or components of, for example, a network entity described herein. For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

For example, as shown in FIG. 1, the processing system 110 may include a (e.g., one or more) communication manager 114 and one or more communication interfaces 116. The communication manager 114 may be configured to perform one or more communication tasks as described herein. In some aspects, the communication manager 114 may direct the communication interface 120 and/or the processing system 110 to perform one or more communication tasks as described herein. Similarly, the processing system 112 may include a (e.g., one or more) communication manager 118 and one or more communication interfaces 120. The communication manager 118 may be configured to perform one or more communication tasks as described herein. In some aspects, the processing system 112 and/or the communication manager 118 may direct the communication interface 120 to perform one or more communication tasks as described herein. Although depicted, for clarity of description, with reference only to the network entities 102 and 104, any one or more of the network entities 102, 104, and 106 also may include a communication manager and a communication interface.

As used herein, “communication interface” refers to an interface that enables communication (e.g., wireless communication, wired communication, or a combination thereof) between a first network entity and a second network entity. A communication interface may include electronic circuitry that enables a network entity to transmit, receive, or otherwise perform the communication. A communication interface may be, be similar to, include, or be included in one or more components that are configured to enable communication between the first network entity and the second network entity. For example, a communication interface may include a transmission component, a reception component, and/or a transceiver, among other examples. For example, a communication interface may include one or more transceivers, one or more receivers, and/or one or more transmitters configured to communicate with other devices, such as via a wired connection, a wireless connection, or a combination of wired and wireless connections. In some examples, a communication interface may include one or more RF components, an RF front end, one or more antennas, one or more transmit or receive processors, a demodulation component, and/or a modulation component, among other examples.

A communication interface may include a transmission component and/or a reception component. For example, a communication interface may include a transceiver and/or one or more separate receivers and/or transmitters that enable a network entity to communicate with other devices, such as via a wired connection, a wireless connection, or a combination of wired and wireless connections. In some examples, a communication interface may include one or more radio frequency reflective elements and/or one or more radio frequency refractive elements. The communication interface may enable the network entity to receive information from another apparatus and/or provide information to another apparatus. In some examples, the communication interface may include an Ethernet interface, an optical interface, a coaxial interface, an infrared interface, an RF interface, a universal serial bus (USB) interface, a Wi-Fi interface, a cellular network interface, a wireless modem, an inter-integrated circuit (I²C), and/or a serial peripheral interface (SPI), among other examples.

As described herein, a network entity (e.g., the network entity 102 and/or the network entity 106) may be configured to perform one or more operations. Reference to a network entity being configured to perform one or more operations may refer to a processing system of the network entity being configured to perform the one or more operations and/or the processing system being configured to cause one or more components of the network entity to perform the one or more operations. For example, reference to the processing system being configured to perform one or more operations may refer to one or more components (or subcomponents) of the processing system performing the one or more operations. For example, the one or more components of the processing system may include at least one memory, at least one processor, and/or at least one communication interface, among other examples, that are configured to perform one or more (or all) of the one or more operations, and/or any combination thereof. Where reference is made to the network entity and/or the processing system being configured to perform operations, the network entity and/or the processing system may be configured to cause one component to perform all operations, or to cause more than one component to collectively perform the operations. When the network entity and/or the processing system is configured to cause more than one component to collectively perform the operations, each operation need not be performed by each of those components (e.g., different operations may be performed by different components) and/or each operation need not be performed in whole by only one component (e.g., different components may perform different sub-functions of an operation).

As described in more detail elsewhere herein, the network entity 102 may (e.g., the processing system 110 may, or the processing system 110 may cause the communication manager 114 and/or the communication interface 116 to: select, in accordance with a first antenna selection policy, one or more first antennas; transmit, using the one or more first antennas, one or more first signals; obtain, based on the one or more first signals, feedback information indicative of a first performance level of the one or more first antennas; select, in accordance with a second antenna selection policy, one or more second antennas, wherein the second antenna selection policy is based on the feedback information; and/or transmit, using the one or more second antennas, one or more second signals. Additionally, or alternatively, the network entity 102 and/or the communication manager 114 may perform one or more other operations described herein.

As described in more detail elsewhere herein, the network entity 106 may (e.g., the processing system 112 may, or the processing system 112 may cause the communication manager 114 and/or the communication interface 116 to: receive one or more signals indicative of an antenna selection result associated with an antenna selection policy of a second network entity (e.g., the network entity 102, the network entity 104, or another network entity); and/or transmit, based on the one or more signals, feedback information indicative of a first performance level of the antenna selection result. Additionally, or alternatively, the network entity 106 and/or the communication manager 118 may perform one or more other operations described herein.

The number and arrangement of entities shown in FIG. 1 are provided as one or more examples. In practice, there may be additional network entities and/or networks, fewer network entities and/or networks, different network entities and/or networks, or differently arranged network entities and/or networks than those shown in FIG. 1. Furthermore, the network entity 102, 104, and 106 may be implemented using a single apparatus or multiple apparatuses.

FIG. 2 is a diagram illustrating an example of a wireless communication network 200, in accordance with the present disclosure. The wireless communication network 200 may be or may include elements of a 5G (or NR) network or a 6G network, among other examples. The wireless communication network 200 may include multiple network nodes 210. For example, in FIG. 2, the wireless communication network 200 includes a network node (NN) 210a and a network node 210b. The network nodes 210 may support communications with multiple UEs 220. For example, in FIG. 2, the network nodes 210 support communication with a UE 220a, a UE 220b, and a UE 220c. In some examples, a UE 220 may also communicate with other UEs 220 and a network node 210 may communicate with a core network and with other network nodes 210.

The network nodes 210 and the UEs 220 of the wireless communication network 200 may communicate using the electromagnetic spectrum, which may be subdivided by frequency or wavelength into various classes, bands, carriers, and/or channels. For example, devices of the wireless communication network 200 may communicate using one or more operating bands. In some aspects, multiple wireless communication networks 200 may be deployed in a given geographic area. Each wireless communication network 200 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 200 may implement dynamic spectrum sharing (DSS), in which multiple RATs are implemented with dynamic bandwidth allocation (for example, based on user demand) in a single frequency band. In some examples, the wireless communication network 200 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 210 and/or a UE 220 may include one or more devices, components, or systems that enable communication with other devices, components, or systems of the wireless communication network 200. For example, a UE 220 and a network node 210 may each include one or more chips, system-on-chips (SoCs), chipsets, packages, or devices that individually or collectively constitute or comprise a processing system, such as a processing system 240 of the UE 220 or a processing system 245 of the network node 210. The processing system 240 and the processing system 245 may be similar to other processing systems described herein, such as the processing system 110 and the processing system 112. A processing system (for example, the processing system 240 and/or the processing system 245) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 240 and the processing system 245 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 240 and the processing system 245 may each include or be coupled with one or more modems (such as a cellular (for example, a 5G or 6G compliant) modem). In some examples, one or more processors of the processing system 240 and/or the processing system 245 include or implement one or more of the modems. The processing system 240 and the processing system 245 may also include or be coupled with multiple radios (collectively “the radio”), multiple RF chains, or multiple transceivers, each of which may in turn be coupled with one or more of multiple antennas. In some examples, one or more processors of the processing system 240 and/or the processing system 245 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 240 of the UE 220 or by the processing system 245 of the network node 210).

A network node 210 and a UE 220 may each include one or multiple antennas or antenna arrays. Typical network nodes 210 and UEs 220 may include multiple antennas, which may be organized or structured into one or more antenna panels, one or more antenna groups, one or more sets of antenna elements, or one or more antenna arrays, among other examples. As used herein, “antenna” can refer to one or more antennas, one or more antenna panels, one or more antenna groups, one or more sets of antenna elements, one or more antenna modules, one or more antenna arrays, and/or one or more antenna sub-elements. The term “antenna panel” can refer to a group of antennas (such as antenna elements) arranged in an array or panel, which may facilitate beamforming by manipulating parameters associated with the group of antennas. “Antenna module” may refer to circuitry including one or more antennas as well as one or more other components (such as filters, amplifiers, or processors) associated with integrating the antenna module into a wireless communication device such as the network node 210 and the UE 220.

An antenna panel, an antenna group, a set of antenna elements, or an antenna array may include one or more antenna elements (within a single housing or multiple housings), one or more coplanar antenna elements, one or more non-coplanar antenna elements, or one or more antenna elements coupled with one or more transmission or reception components, such as the processing system 240 and/or the processing system 245. “Antenna element” refers to single radiating (for example, transmitting) and/or receiving point included in an antenna array. An antenna array may also be referred to as a “sub-array.” An antenna array may include one or more antenna elements where each antenna element is configured as a single unit for radiating (for example, transmitting) and/or receiving. In some examples, each of the antenna elements of an antenna may include one or more sub-elements for radiating and/or transmitting or receiving RF signals. A “sub-element” refers to an individual component (e.g., an individually controllable component) within an antenna element, such as an individual radiating unit. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and/or destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range. In some examples, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 220 or network nodes 210 may include different numbers of antenna elements. For example, a UE 220 may include a single antenna element, two antenna elements, four antenna elements, eight antenna elements, or a different number of antenna elements. As another example, a network node 210 may include eight antenna elements, 24 antenna elements, 64 antenna elements, 128 antenna elements, or a different number of antenna elements. Advantages of using a larger number of antenna elements may provide include providing increased control over parameters for beam generation relative to a smaller number of antenna elements, whereas advantages of using a smaller number of antenna elements may be include reducing implementation complexity, and/or reduced power consumption compared to than use of a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

Advancements in antenna designs may be driven by the need for faster data rates, lower latency, and/or more reliable connectivity in advancement systems, such as 6G systems, massive multiple-input multiple-output (massive MIMO) systems, among other examples. For example, the wireless communication network 200 may operate using higher frequency bands, such as millimeter wave frequencies and/or terahertz (THz) frequencies, which enable faster data transmissions and increased bandwidth. To enable UEs 220 and network nodes 210 to communicate using these higher frequency bands, antennas (and/or antenna elements) of the UEs 220 and network nodes 210 may be configured to address the increased signal attenuation and/or limited range associated with these higher frequency bands. For example, a UE 220 and/or a network node 210 may use advanced beamforming techniques, such as AI/ML-based beamforming techniques (for example, in which an AI/ML model can be used to dynamically adjust beamforming patterns in response to changing network conditions, channel conditions, and/or UE location, among other examples, to improve signal strength and/or reduce interference). Additionally, the antennas may have a higher density of antenna elements to enable more precise beam steering and/or to increase the quantity of independent beams that can be formed simultaneously using an antenna panel (thereby supporting an increased quantity of simultaneous connections). Additionally, the wireless communication network 200 may include one or more devices that have dynamically configurable antenna panels and/or antenna elements (for example, for an intelligent reflecting surface (IRS) and/or a reconfigurable intelligent surface (RIS)) to improve coverage and signal strength.

In some examples, a UE 220 and/or a network node 210 may use an inference model (for example, an AI/ML model) to obtain one or more inferences or predictions for beamforming. An output of the inference model may include a codebook based spatial domain selection or prediction (for example, that indicates one or more predicted measurement values for one or more beams) and/or a non-codebook based spatial domain selection or prediction (for example, that indicates one or more parameters for a beam, such as a point-direction, an angle of departure (AoD), and/or an angle of arrival (AoA), among other examples). The UE 220 and/or the network node 210 may configure one or more antenna elements to form one or more beams in accordance with the output of the inference model.

A network node 210 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 210 may be implemented as a single physical node (for example, a single physical structure) or may be implemented as two or more physical nodes (for example, two or more distinct physical structures). For example, a network node 210 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 210 may be an aggregated network node having an aggregated architecture, meaning that the network node 210 may implement a full radio protocol stack that is physically and logically integrated within a single physical structure in the wireless communication network 200. For example, an aggregated network node 210 may consist of a single standalone base station or a single TRP that operates with a full radio protocol stack to enable or facilitate communication between a UE 220 and a core network of the wireless communication network 200.

Alternatively, and as also shown, a network node 210 may be a disaggregated network node (sometimes referred to as a disaggregated base station), having a disaggregated architecture, meaning that the network node 210 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 210 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 210 of the wireless communication network 200 may include one or more CUs, one or more DUs, and one or more RUs. A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 220. In some examples, a single network node 210 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 210 (for example, a base station, an RU, or a TRP) may provide communication coverage for a particular geographic area. The term “cell” can refer to a coverage area of a network node 210 or to a network node 210 itself, depending on the context in which the term is used. A network node 210 may support one or more cells (for example, each cell may support communication within an angular (for example, 60 degree) range around the network node). In some examples, a network node 210 may provide communication coverage for a macro cell, a pico cell, a femto cell, or another type of cell. A macro cell may cover a relatively large geographic area (for example, several kilometers in radius) and may allow unrestricted access by UEs 220 with associated service subscriptions. A pico cell may cover a relatively small geographic area and may also allow unrestricted access by UEs 220 with associated service subscriptions. A femto cell may cover a relatively small geographic area (for example, a home) and may allow restricted access by UEs 220 having association with the femto cell (for example, UEs 220 in a closed subscriber group (CSG)). In some examples, a cell may not necessarily be stationary. For example, the geographic area of the cell may move according to the location of an associated mobile network node 210 (for example, a train, a satellite, an unmanned aerial vehicle, or an NTN network node).

The wireless communication network 200 may be a heterogeneous network that includes network nodes 210 of different types, such as macro network nodes, pico network nodes, femto network nodes, relay network nodes, aggregated network nodes, and/or disaggregated network nodes, among other examples. Various different types of network nodes 210 may generally transmit at different power levels, serve different coverage areas (for example, a cell 230a and a cell 230b), and/or have different impacts on interference in the wireless communication network 200 than other types of network nodes 210.

The UEs 220 may be physically dispersed throughout the coverage area of the wireless communication network 200, and each UE 220 may be stationary or mobile. A UE 220 may be, may include, or may also be referred to as an access terminal, a mobile station, or a subscriber unit. A UE 220 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 220 may be classified according to different categories in association with different complexities and/or different capabilities. UEs 220 in a first category may facilitate massive IoT in the wireless communication network 200, and may offer low complexity and/or cost relative to UEs 220 in a second category. UEs 220 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 200, among other examples. A third category of UEs 220 may have mid-tier complexity and/or capability (for example, a capability between that of the UEs 220 of the first category and that of the UEs 220 of the second capability). A UE 220 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 210 may be, may include, or may operate as an RU, a TRP, or a base station that communicates with one or more UEs 220 via a radio access link (which may be referred to as a “Uu” link). The radio access link may include a downlink and an uplink. “Downlink” (or “DL”) refers to a communication direction from a network node 210 to a UE 220, and “uplink” (or “UL”) refers to a communication direction from a UE 220 to a network node 210. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 220 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 210 transmitting a downlink control information (DCI) configuration to the one or more UEs 220) and/or reconfigured (for example, in real-time or near-real-time) according to changing network conditions in the wireless communication network 200 and/or specific requirements of one or more UEs 220. An active BWP defines the operating bandwidth of the UE 220 within the operating bandwidth of the serving cell. The use of BWPs enables more efficient use of the available frequency domain resources in the wireless communication network 200 because fewer frequency domain resources may be allocated to a BWP for a UE 220 (which may reduce the quantity of frequency domain resources that a UE 220 is required to monitor and reduce UE power consumption by enabling the UE to monitor fewer frequency domain resources), leaving more frequency domain resources to be spread across multiple UEs 220. Thus, BWPs may also assist in the implementation of lower-capability (for example, RedCap) UEs 220 by facilitating the configuration of smaller bandwidths for communication by such UEs 220 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 210 to a UE 220. DCI generally contains the information the UE 220 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 220) from a network node 210 to a UE 220. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 220 to a network node 210. An uplink data channel may be used to transmit uplink data (for example, user data associated with a UE 220) from a UE 220 to a network node 210. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 210), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 210 to a UE 220, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 210 or UE 220 over a wireless communication channel. In some examples, the network node 210 or the UE 220 (for example, using the processing system 245 or the processing system 240, respectively) may select an MCS (for example, an order of quadrature amplitude modulation (QAM), such as 64-QAM, 128-QAM, or 256-QAM, among other examples) for a downlink signal or an uplink signal. For example, the network node 210 may select an MCS for a downlink signal in accordance with UCI received from the UE 220. The network node 210 may transmit, to the UE 220, an indication of the selected MCS for the downlink signal, such as via DCI that schedules the downlink signal. As another example, the network node 210 may transmit, and the UE 220 may receive, an indication of an MCS to be applied for the one or more uplink signals, such as via DCI scheduling transmission of the one or more uplink signals.

The network node 210 or the UE 220 (such as by using the processing system 245 or the processing system 240, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 210 or the UE 220 (for example, using the processing system 245 or the processing system 240, respectively, and/or one or more coupled encoders or modems) may perform a channel coding operation or a forward error correction (FEC) operation to control errors in transmitted information. For example, the network node 210 or the UE 220 may perform an encoding operation to generate encoded information (such as by selectively introducing redundancy into the information, typically using an error correction code (ECC), such as a polar code or a low-density parity-check (LDPC) code). The network node 210 or the UE 220 (for example, using the processing system 245 and/or one or more modems) may further perform spatial processing (for example, precoding) on the encoded information to generate one or more processed or precoded signals for downlink or uplink transmission, respectively. In some examples, the network node 210 or the UE 220 may perform codebook-based precoding or non-codebook-based precoding. Codebook-based precoding may involve selecting a precoder (for example, a precoding matrix) using a codebook. For example, the network node 210 may provide precoding information indicating which precoder, defined by the codebook, is to be used by the UE 220. Non-codebook-based precoding may involve selecting or deriving a precoder based on, or otherwise associated with, one or more downlink or uplink signal measurements. The network node 210 or the UE 220 may transmit the processed downlink or uplink signals, respectively, via one or more antennas.

The network node 210 or the UE 220 may receive uplink signals or downlink signals, respectively, via one or more antennas. The network node 210 or the UE 220 (for example, using the processing system 245 or the processing system 240, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 210 or the UE 220 via the downlink or uplink signals. The network node 210 or the UE 220 (for example, using the processing system 245 or the processing system 240, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 220 and a network node 210 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 210 and/or UE 220 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 210b may generate one or more beams 260a, and the UE 220b may generate one or more beams 260b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 210 and/or at the UE 220, such as in a network implementing mmWave technology. Massive MIMO may improve communication reliability by enabling a network node 210 and/or a UE 220 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 210 and the UE 220 may perform one or more beam management operations, such as an initial beam acquisition operation, one or more beam refinement operations, and/or a beam recovery operation. For example, an initial beam acquisition operation may involve the network node 210 transmitting signals (for example, SSBs, CSI-RSs, or other signals) via respective beams (for example, of the beams 260a of the network node 210) and the UE 220 receiving and measuring the signal(s) via respective beams of multiple beams (for example, from the beams 260b of the UE 220) to identify a best beam (or beam pair) for communication between the UE 220 and the network node 210. For example, the UE 220 may transmit an indication (for example, in a message associated with a random access channel (RACH) operation) of a (best) identified beam of the network node 210 (for example, by indicating an SSBRI or other identifier associated with the beam). A beam refinement operation may involve a first device (for example, the UE 220 or the network node 210) transmitting signal(s) via a subset of beams (for example, identified based on, or otherwise associated with, measurements reported as part of one or more other beam management operations). A second device (for example, the network node 210 or the UE 220) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 210 and the UE 220 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 265 (for example, one or more network nodes 210, one or more UEs 220, and/or one or more servers, and/or one or more components of a cloud computing network, among other examples). For example, in an deployment where AI/ML functionality is performed independently at a device 265, sometimes referred to as “overlay AI/ML”, the AI/ML model (or an instance or portion of the AI/ML model) may be deployed at a UE 220 (for example, at the processing system 240), a network node 210 (for example, at the processing system 245), one or more servers, and/or one or more components of a cloud computing network, among other examples. Additionally or alternatively, in a deployment where AI/ML functionality is coordinated between different devices 265, sometimes referred to as “coordinated AI/ML”, or performed at all device and network layers, sometimes referred to as “native AI/ML”, the AI/ML model (or an instance of the AI/ML model) may be deployed at multiple devices 265 (for example, a first portion of the AI/ML model may be deployed at a UE 220 and a second portion of the AI/ML model may be deployed at a network node 210). In other examples of coordinated AI/ML and/or native AI/ML, a first AI/ML model may be deployed at a UE 220 and a second AI/ML model may be deployed at a network node 210. The AI/ML model(s) may be configured to enhance various aspects of the wireless communication network 200 (for example, to increase privacy, reliability, and/or efficient use of network bandwidth, and/or to reduce latency, among other examples). For example, the AI/ML model(s) may be trained to identify patterns or relationships in data corresponding to the wireless communication network 200, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 220, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, the UE 220 may include a communication manager 250. As described in more detail elsewhere herein, the communication manager 250 may select, in accordance with a first antenna selection policy, one or more first antennas; transmit, using the one or more first antennas, one or more first signals; obtain, based on the one or more first signals, feedback information indicative of a first performance level of the one or more first antennas; select, in accordance with a second antenna selection policy, one or more second antennas, wherein the second antenna selection policy is based on the feedback information; and/or transmit, using the one or more second antennas, one or more second signals. Additionally, or alternatively, the communication manager 250 may perform one or more other operations described herein.

In some aspects, the network node 210 may include a communication manager 255. As described in more detail elsewhere herein, the communication manager 255 may receive one or more signals indicative of an antenna selection result associated with an antenna selection policy of a network entity (e.g., a UE 220); and/or transmit, based on the one or more signals, feedback information indicative of a first performance level of the antenna selection result. Additionally, or alternatively, the communication manager 255 may perform one or more other operations described herein.

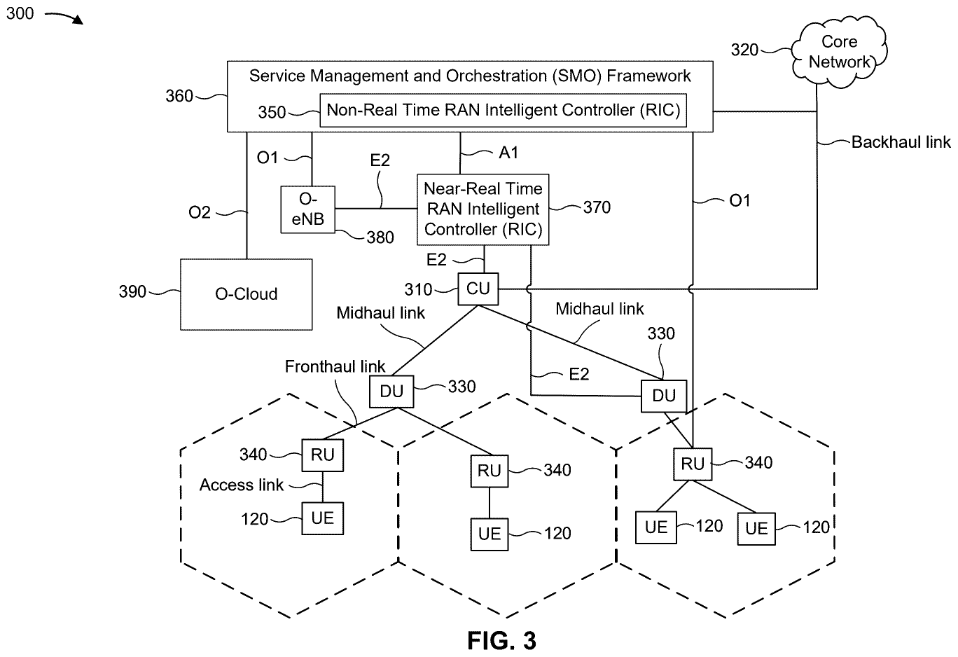

FIG. 3 is a diagram illustrating an example disaggregated network node architecture 300, in accordance with the present disclosure. One or more components of the example disaggregated network node architecture 300 may be, may include, or may be included in one or more network nodes (such one or more network nodes 210). The disaggregated network node architecture 300 may include a CU 310 that can communicate directly with a core network 320 via a backhaul link, or that can communicate indirectly with the core network 320 via one or more disaggregated control units, such as a non-real-time (Non-RT) RAN intelligent controller (RIC) 350 associated with a Service Management and Orchestration (SMO) Framework 360 and/or a near-real-time (Near-RT) RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 220 via respective RF access links. In some deployments, a UE 220 may be simultaneously served by multiple RUs 340.

Each of the components of the disaggregated network node architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB 380 with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

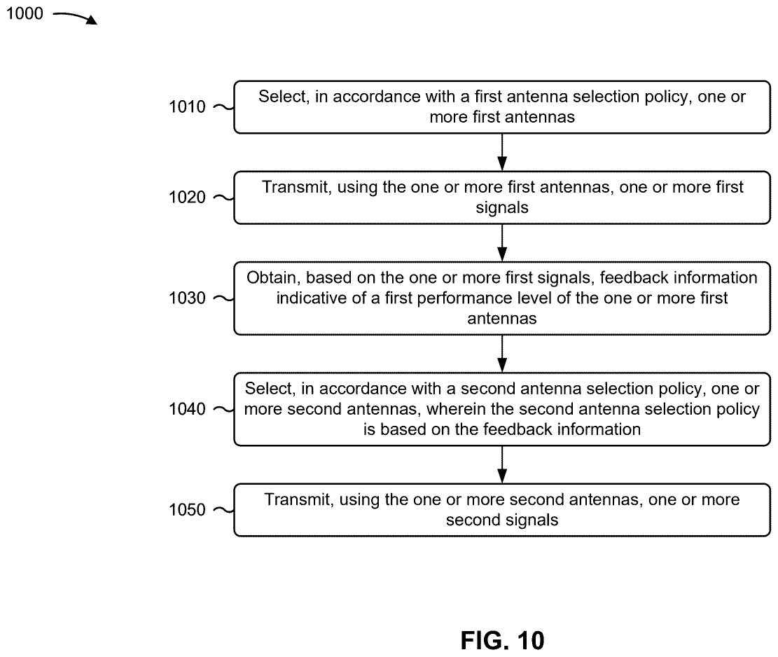

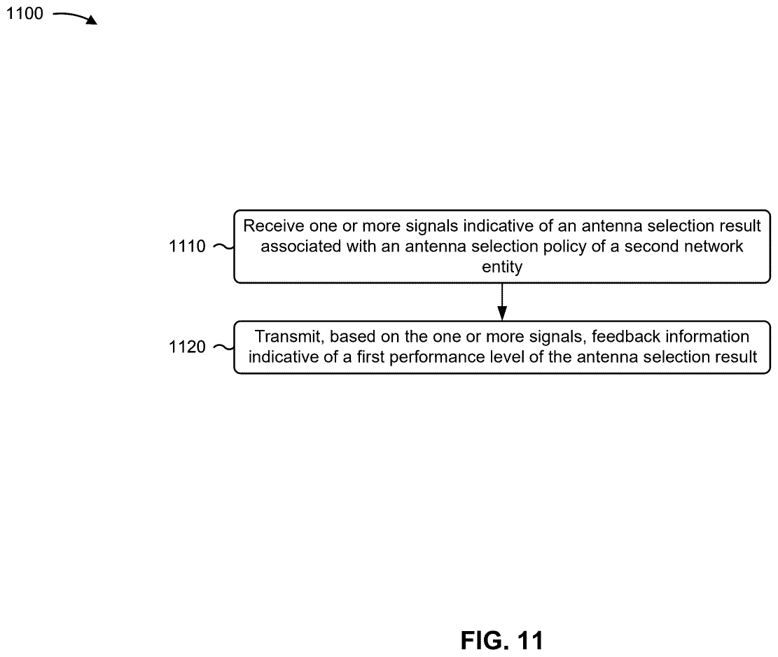

The network entity 102, the processing system 110 of the network entity 102, the network entity 106, the processing system 112 of the network entity 106, the network node 210, the processing system 245 of the network node 210, the UE 220, the processing system 240 of the UE 220, the CU 310, the DU 330, the RU 340, or any other component(s) of FIGS. 1-3 may implement one or more techniques or perform one or more operations associated with policy updates for antenna selection, as described in more detail elsewhere herein. For example, the processing system 110 of the network entity 102, the processing system 112 of the network entity 106, the processing system 245 of the network node 210, the processing system 240 of the UE 220, the CU 310, the DU 330, or the RU 340 may perform or direct operations of, for example, process 1000 of FIG. 10, process 1100 of FIG. 11, or other processes as described herein (alone or in conjunction with one or more other processors). Memory of the network node 210 may store data and program code (or instructions) for the network node 210, the CU 310, the DU 330, or the RU 340. In some examples, the memory of the network node 210 may store data relating to a UE 220, such as RRC state information or a UE context. Memory of a UE 220 may store data and program code (or instructions) for the UE 220, such as context information. In some examples, the memory of the UE 220 or the memory of the network node 210 may include a non-transitory computer-readable medium storing a set of instructions for wireless communication. For example, the set of instructions, when executed by one or more processors (for example, of the processing system 110, the processing system 112, the processing system 245, or the processing system 240) of the network entity 102, the network entity 106, the network node 210, the UE 220, the CU 310, the DU 330, or the RU 340, may cause the one or more processors to perform process 1000 of FIG. 10, process 1100 of FIG. 11, or other processes as described herein. In some examples, executing instructions may include running the instructions, converting the instructions, compiling the instructions, and/or interpreting the instructions, among other examples.

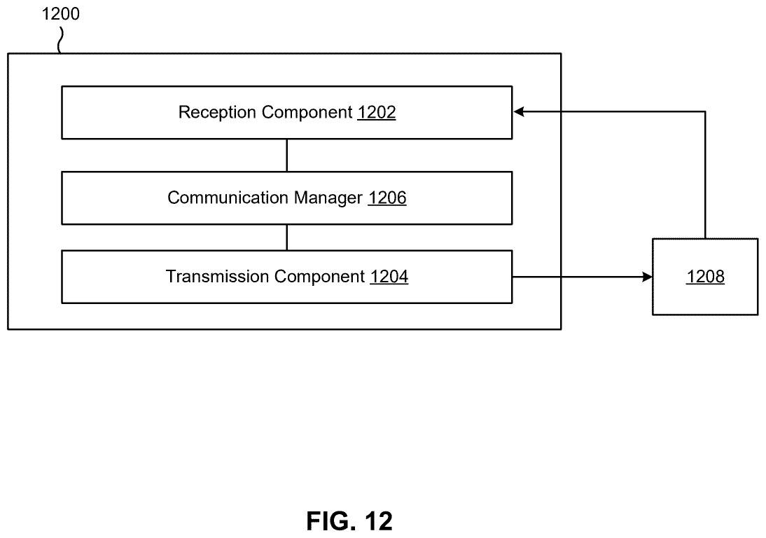

In some aspects, the first network entity includes means for selecting, in accordance with a first antenna selection policy, one or more first antennas; means for transmitting, using the one or more first antennas, one or more first signals; means for obtaining, based on the one or more first signals, feedback information indicative of a first performance level of the one or more first antennas; means for selecting, in accordance with a second antenna selection policy, one or more second antennas, wherein the second antenna selection policy is based on the feedback information; and/or means for transmitting, using the one or more second antennas, one or more second signals. In some aspects, the means for the first network entity to perform operations described herein may include, for example, one or more of communication manager 250, processing system 240, processing system 110, communication manager 114, communication interface 116, processing system 112, communication manager 118, communication interface 120, a radio, one or more RF chains, one or more transceivers, one or more antennas, one or more modems, a reception component (for example, reception component 1202 depicted and described in connection with FIG. 12) and/or a transmission component (for example, transmission component 1204 depicted and described in connection with FIG. 12), among other examples.

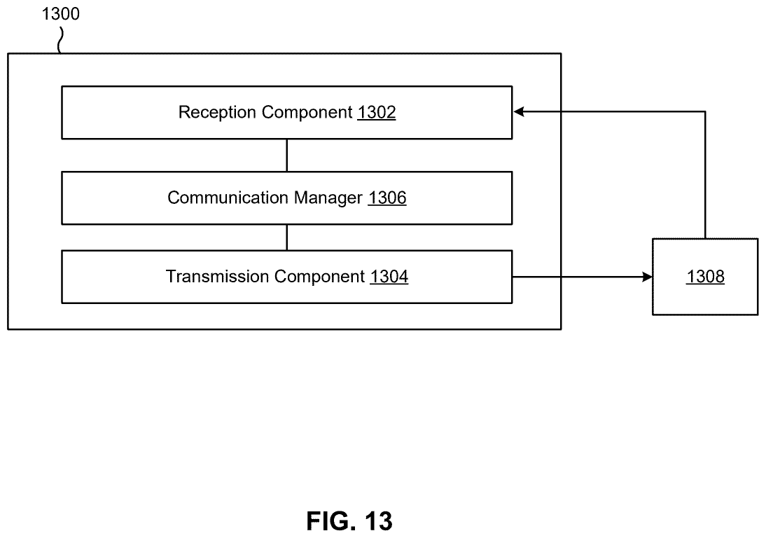

In some aspects, the first network entity includes means for receiving one or more signals indicative of an antenna selection result associated with an antenna selection policy of a second network entity; and/or means for transmitting, based on the one or more signals, feedback information indicative of a first performance level of the antenna selection result. In some aspects, the means for the first network entity to perform operations described herein may include, for example, one or more of communication manager 255, processing system 245, processing system 110, communication manager 114, communication interface 116, processing system 112, communication manager 118, communication interface 120, a radio, one or more RF chains, one or more transceivers, one or more antennas, one or more modems, a reception component (for example, reception component 1302 depicted and described in connection with FIG. 13), and/or a transmission component (for example, transmission component 1304 depicted and described in connection with FIG. 13), among other examples.

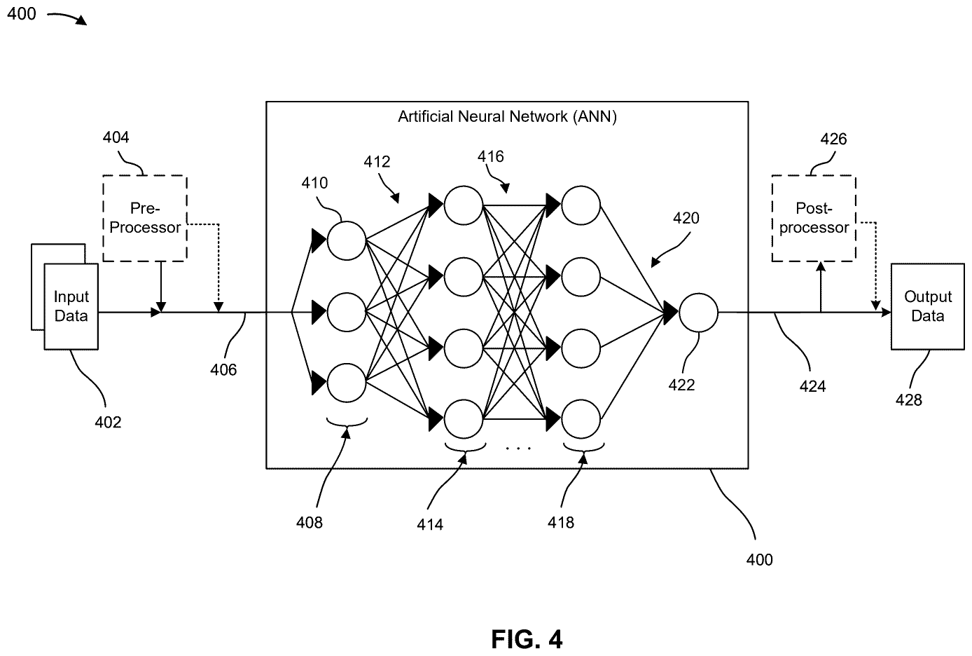

FIG. 4 is a diagram illustrating an example artificial intelligence and/or AI/ML model, represented in FIG. 4 as an artificial neural network (ANN) 400, in accordance with the present disclosure.

As shown in FIG. 4, the ANN 400 may receive input data 406, which may include one or more bits of data 402, pre-processed data output from pre-processor 404 (which is optional), or some combination thereof. Here, the bits of data 402 may include training data, verification data, application-related data, or the like, based, for example, on the stage of deployment of ANN 400. In some examples, the pre-processor 404 may be included within the ANN 400. The pre-processor 404 may, for example, process all or a portion of data 402, which may result in some of data 402 being changed, replaced, and/or deleted, among other examples. In some aspects, the pre-processor 404 may add additional data to data 402. In some aspects, the pre-processor 404 may be an AI/ML model, such as an ANN.

As shown in FIG. 4, the ANN 400 includes at least one first layer 408 of artificial neurons 410 to process input data 406 and provide resulting first layer data via connections or “edges” such as edges 412 to at least a portion of at least one second layer 414. The second layer 414 processes data received via edges 412 and provides second layer output data via edges 416 to at least a portion of at least one third layer 418. The third layer 418 processes data received via edges 416 and provides third layer output data via edges 420 to at least a portion of a final layer 422 including one or more neurons to provide output data 424. All or part of output data 424 may be further processed in some manner by (optional) post-processor 426. Thus, in certain examples, the ANN 400 may provide output data 428 that is based on output data 424, post-processed data output from post-processor 426, or some combination thereof.

The post-processor 426 may be included within the ANN 400 in some examples. The post-processor 426 may, for example, process all or a portion of output data 424, which may result in output data 428 being different, at least in part, to output data 424, as result of data being changed, replaced, and/or deleted, among other examples. In some examples, post-processor 426 may be configured to add additional data to output data 424. In this example, the second layer 414 and the third layer 418 represent intermediate or hidden layers that may be arranged in a hierarchical or other like structure. Although not explicitly shown in FIG. 4, there may be one or more further intermediate layers between the second layer 414 and the third layer 418. In some examples, the post-processor 426 may be an AI/ML model, such as an ANN.

The structure and training of artificial neurons 410 in the various layers may be tailored to specific requirements of an application. Within a given layer such as first layer 408, second layer 414, or third layer 418 of the ANN 400, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of the ANN 400. The weights and biases of the ANN 400 may be adjusted during a training process or during operation of the ANN 400. The weights of the various artificial neurons may control a strength of connections between layers or artificial neurons, while the biases may control a direction of connections between the layers or artificial neurons. An activation function may select or determine whether an artificial neuron transmits an output to the next layer in response to received data.

Different activation functions may be used to model different types of non-linear relationships. By introducing non-linearity into an AI/ML model, an activation function allows the configuration for the AI/ML model to change in response to identifying or detecting complex patterns and relationships in the input data 406. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an AI/ML model, such as ANN 400, may be conducted using training data. Training data may include one or more datasets that the ANN 400 may use to identify patterns or relationships. Training data may represent various types of information, including written, visual, audio, environmental context, and/or operational properties, among other examples. During training, the parameters (such as the weights and biases) of artificial neurons 410 may be changed, such as to minimize or otherwise reduce a loss function or a cost function. A training process may be repeated multiple times to fine-tune the ANN 400 with each iteration.

Various ANN model structures are available for consideration. For example, the ANN 400 may implement or may be implemented in a feedforward ANN structure, a convolutional ANN structure, a recurrent ANN structure, an autoencoder ANN structure, a generative adversarial ANN structure, or a transformer ANN structure. Another example ANN structure is an AI/ML model with one or more invertible layers. Models of this type may be inverted or “unwrapped” to reveal the input data that was used to generate the output of a layer. Other example types of ANN model structures include fully connected neural networks (FCNNs) and long short-term memory (LSTM) networks, among others.

The ANN 400 or other AI/ML models may be implemented in various types of processing circuits along with memory and applicable instructions therein. For example, general-purpose hardware circuits, such as, such as one or more CPUs, one or more GPUs, or suitable combinations thereof, may be employed to implement a model. In some implementations, one or more tensor processing units (TPUs), NPUs, or other special-purpose processors, field-programmable gate arrays (FPGAs), ASICs, or the like may also be employed. In some implementations, the AI/ML model may be implemented by a NPU or a TPU embedded in an SoC along with other components, such as one or more CPUs, GPUs, or the like. An SoC includes several components manufactured on a shared semiconductor substrate. The NPU or TPU may be controlled by the one or more CPUs by configuring the AI/ML model implemented by the NPU or TPU with weights and biases, providing certain training data to the AI/ML model to configure the AI/ML model, or providing input data to the AI/ML model to obtain related inferences. The one or more CPUs may also receive the inferences and be configured to perform certain actions based on the inferences produced by the AI/ML model. The actions performed by the one or more CPUs may include sending commands to other components of the SoC or components external to the SoC to perform certain actions. For example, the CPU may send commands to an RF transceiver based on the outputs or inferences obtained from an AI/ML model to cause the RF transceiver to operate on a wireless network in accordance with the AI/ML model.

As indicated above, FIG. 4 is provided as an example. Other examples may differ from what is described with regard to FIG. 4.

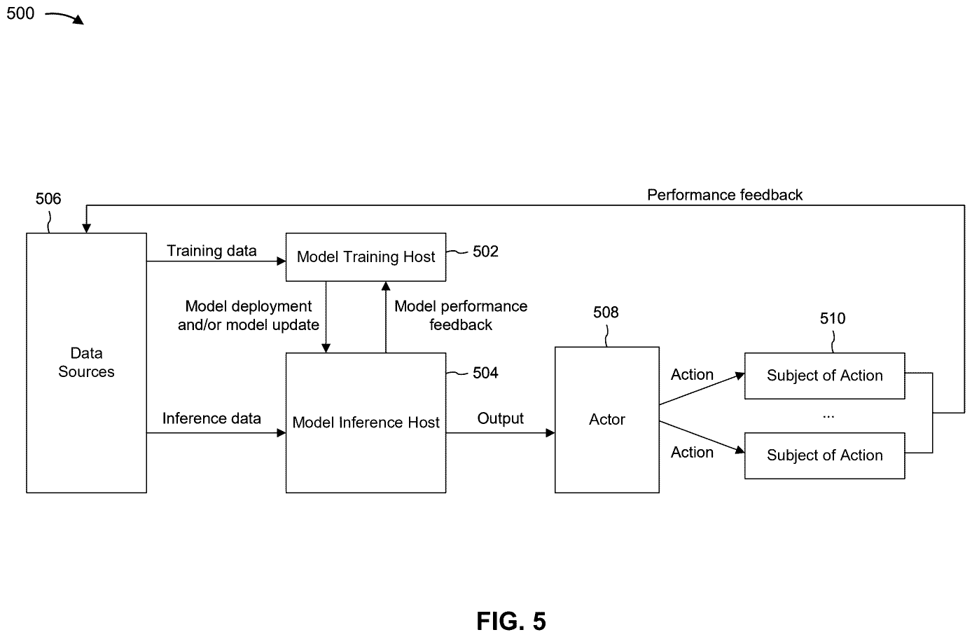

FIG. 5 is a diagram illustrating an example architecture 500 of a functional framework for RAN intelligence enabled by data collection, in accordance with the present disclosure. In some scenarios, the functional framework for RAN intelligence may be enabled by enhancement of the data collection through one or more use cases and/or examples. For example, principles or algorithms for RAN intelligence enabled by AI/ML and the associated functional framework (e.g., AI/ML functionalities, inputs and/or outputs of one or more components for AI/ML enabled optimization, or the like) may be used for one or more AI/ML air interface use cases (e.g., beam management, positioning, CSI prediction, energy saving, load balancing, mobility management, and/or coverage optimization, among other examples). In one example, as shown by the architecture 500, a functional framework for RAN intelligence may include multiple logical entities, such as a model training host 502, a model inference host 504, one or more data sources 506, and an actor 508.

The model inference host 504 may be configured to run an AI/ML model based on inference data provided by the data sources 506, and the model inference host 504 may produce an output (e.g., a prediction or inference) associated with the inference data according to an AI/ML functionality. The model inference host 504 may be, or may be included in, the device 265. As further shown in FIG. 5, the output produced by the model inference host 504 may be provided to the actor 508. The actor 508 may be an element or an entity of a core network or a RAN. For example, the actor 508 may be a network entity, a UE, a network node, a base station (e.g., a gNB), a CU, a DU, and/or an RU, among other examples. In addition, the actor 508 may depend on a type of tasks performed by the model inference host 504, a type of the inference data provided to the model inference host 504, and/or a type of the output produced by the model inference host 504. For example, if the output from the model inference host 504 is associated with position determination, the actor 508 may be a UE, a network node such as a DU or an RU, or another suitable device such as a location management function (LMF). In some examples, the model inference host 504 may be hosted on the actor 508. For example, a UE may be the actor 508 and may host the model inference host 504. In some aspects, a UE (e.g., the actor 508) may be a data source 506. For example, the UE may perform a measurement (e.g., a first set of beam measurements), may input the measurement to the AI/ML model at the model inference host 504 (or may provide the measurement to the model inference host 504), and may act based on an output of the AI/ML model (e.g., mapping the first set of beam measurements to a second set of beam measurements, a position, a precoder or precoding matrix, a CQI, an RI, a mobility or handover parameter, and/or a compressed representation of CSI feedback).

After the actor 508 receives an output from the model inference host 504, the actor 508 may determine whether to act based on the output. For example, if the actor 508 is a UE and the output from the model inference host 504 is associated with position information, the actor 508 may determine whether to report the position information, reconfigure a beam, among other examples. Additionally, or alternatively, if the actor 508 is a UE and the output from the model inference host 504 is a predicted beam measurement, the actor 508 may report predicted channel characteristics associated with one or more target resources in one or more temporal occasions. If the actor 508 determines to act based on the output, in some examples, the actor 508 may indicate the action to at least one subject of action 510.

The data sources 506 may also be configured for collecting data that is used as training data for training an AI/ML model or as inference data for feeding an AI/ML model inference operation. For example, the data sources 506 may collect data from one or more core network and/or RAN entities, which may include the actor 508 or the subject of action 510, and may provide the collected data to the model training host 502 for AI/ML model training. In some aspects, the model training host 502 may be co-located with the model inference host 504 and/or the actor 508. For example, the actor 508 or the subject of action 510 may provide performance feedback associated with the action performed by the actor 508 and/or the output from the model inference host 504 to the data sources 506. In some examples, the performance feedback may be used by the model training host 502 for monitoring or evaluating the AI/ML model performance. For example, the performance feedback may be used by the model training host 502 to determine whether the output (e.g., prediction or inference) provided to the actor 508 is accurate. In some examples, the model training host 502 may monitor or evaluate AI/ML model performance using a training position value, which may be provided by a node (e.g., a UE or a network node). In some examples, if the output provided by the model inference host 504 is inaccurate (or the accuracy is below an accuracy threshold), then the model training host 502 may modify and/or retrain the AI/ML model used by the model inference host 504 (e.g., via an AI/ML model deployment and/or update).

As indicated above, FIG. 5 is provided as an example. Other examples may differ from what is described with regard to FIG. 5.

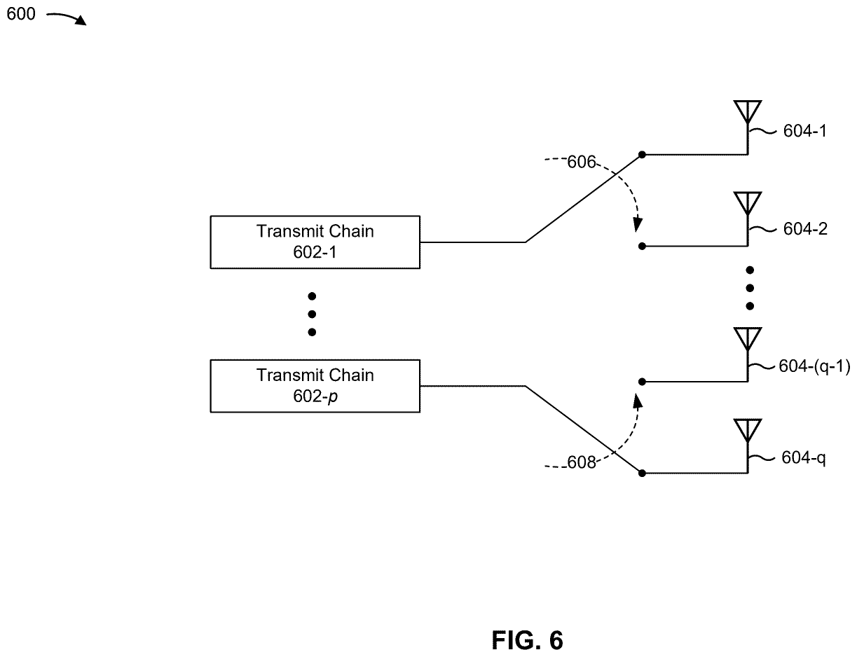

FIG. 6 is a diagram illustrating an example 600 of antenna selection, in accordance with the present disclosure.

A network entity, such as a network node and/or a UE, may include fewer transmit chains than antennas. To illustrate, the example 600 includes p transmit chains (shown as transmit chain 602-1 up to transmit chain 602-p) and q antennas (shown as antenna 604-1, antenna 604-2, antenna 602-(q−1), up to antenna 602-q) that may be included in a same network entity, where p is a first integer, q is a second integer, and p is less than or equal to q. For instance, a UE may include the p transmit chains as uplink transmit chains and/or sidelink transmit chains that may result in the UE supporting a maximum number of p baseband layers in a transmission. Some of the q antennas that are not connected to a transmit chain may be used as receive antennas and/or may be coupled to one or more receiver chains.

In some aspects, a network entity may include a capability to switch connections between a transmit chain and an antenna. For instance, as shown by reference number 606, the network entity may decouple the transmit chain 602-1 from the antenna 604-1 and couple the transmit chain 602-1 to the antenna 604-2. Alternatively, or additionally, as shown by reference number 608, the network entity may decouple the transmit chain 602-p from the antenna 604-q and couple the transmit chain 602-p to the antenna 604-(q−1). The ability for a network entity to switch and/or change connections between transmit chains and antennas may enable the network entity to dynamically select and/or switch an antenna configuration (e.g., one or more antennas out of a set of antennas) that results in a higher signal quality relative to using a different antenna configuration. That is, the network entity may switch antenna configurations to achieve a best antenna configuration (e.g., out of a set of antennas) that increases a signal quality. Examples of a higher signal quality may include a first signal with a higher signal power level, a lower interference level, and/or a higher signal-to-noise ratio (SNR) relative to a second signal. To determine a best antenna configuration out of a set of antennas, the network entity may use and/or analyze a variety of factors, such as a per-antenna transmit power budget and/or one or more propagation channel characteristics of a channel between a transmitting network entity and a receiving network entity (e.g., a UE and a network node, respectively, for an uplink channel). Characteristics of a propagation channel may be computed and/or derived using one or more measurement metrics, such as a CSI metric, an SNR metric, a signal-to-interference-plus-noise ratio (SINR) metric, and/or an RSSI metric.

An uplink multiple-input-multiple-output (MIMO) channel that is based at least in part on p uplink transmit chains and M network node transmit-receive units (TXRUs) may be represented as follows:

$${H}_{UL} = [ \begin{matrix}{J}_{0} & ⋯ & \\ ⋮ & ⋱ & ⋮ \\ & ⋯ & {J}_{N - 1}\end{matrix} ] P L \cdot {R}^{NN ( \frac{1}{2} )} {H}_{w} {R}^{UE ( \frac{H}{2} )} [ \begin{matrix}{I}_{0} & ⋯ & \\ ⋮ & ⋱ & ⋮ \\ & ⋯ & {I}_{p - 1}\end{matrix} ] [ \begin{matrix}\sqrt{{P}_{0}} & ⋯ & \\ ⋮ & ⋱ & ⋮ \\ & ⋯ & \sqrt{{P}_{p - 1}}\end{matrix} ] W$$

where J₀ to J_{N-1} form a network node insertion loss matrix (e.g., J), PL is a channel propagation loss from a UE to a network node, R^{NN(1/2)} is a network node receive antenna correlation matrix, H_{w} is a uncorrelated fast fading channel component matrix, R^{UE(H/2)} is a UE transmit antenna correlation matrix, I₀ to Iₚ₋₁ form a UE insertion loss matrix (e.g., I), P₀ to Pₚ₋₁ form an uplink transmit power matrix (e.g., P), and W is a precoding matrix.

In some aspects, the insertion loss matrices (e.g., I and J) and the antenna correlation matrices (e.g., R^{UE} and R^{NN}) may not be reciprocals of one another, such as in a scenario in which calibration between the uplink and the downlink does not exist (e.g., uplink and downlink are uncalibrated with one another). The lack of reciprocity between the insertion loss matrices and the antenna correlation matrices may make the acquisition of individual values within the matrices difficult and, consequently, selection of a best antenna configuration difficult.

As one example, based on a network node being calibrated (e.g., calibration between uplink and downlink), the network node insertion loss matrix J and the network node receive antenna correlation matrix R^{NN} may be reciprocal between an uplink channel and a downlink channel. Calibration between uplink and downlink at a UE, however, may be difficult to achieve, such that the UE insertion loss matrix I and the UE transmit antenna correlation matrix R^{UE} may lack reciprocity between an uplink channel and a downlink channel. For example, a UE may be able to perform calibration between a modem of the UE and one or more test ports (e.g., test antenna ports used for calibration). However, there may be one or more components (e.g., RF components, such as connector(s) and/or antennas) after the test port in a transmit chain for which the UE may be unable to perform calibration. In some examples, an uplink measurement metric (e.g., measured by a network node) may provide more information relative to a downlink measurement metric (e.g., measured by a UE) that enables a network entity to select an antenna configuration (e.g., one or more particular antennas out of a set of antennas) that provides a higher signal quality relative to other antenna configurations.

To illustrate, a UE may perform uplink antenna selection in an open-loop manner that is transparent to a network node. For example, the UE may compute one or more measurements based at least in part on receiving one or more downlink signals (e.g., downlink reference signals) using a set of antennas, such as by receiving a downlink signal via a first antenna, generating a first measurement metric using the downlink signal, receiving the downlink signal via a second antenna, and generating a second measurement metric using the downlink signal. The UE may compare the first and the second measurement metrics to determine which antenna and/or antenna configuration is linked to a higher signal quality. Based at least in part on an assumption that at least some reciprocity exists between a downlink channel and an uplink channel, the UE may select an uplink antenna configuration using the antenna that produces a higher signal quality for a downlink signal.

However, and as described above, reciprocity between the uplink channel and the downlink channel may not exist, such as in a scenario that includes a mismatch between the uplink channel and the downlink channel due in part to insertion losses, antenna correlations, and/or wireless channel parameters, among other examples. Based on the mismatch, the open-loop approach to selecting an antenna configuration by a UE may result in decreased signal quality (e.g., reduced signal power level and/or reduced SNR), such as in communication scenarios that use frequency division duplexing (FDD), a supplementary uplink (SUL), and/or an uplink reception point that is different from a downlink transmission point. Accordingly, the UE selecting an uplink antenna configuration using a downlink reciprocity assumption as described above may lead to decreased signal quality that results in increased recovery errors, increased data transfer delays, and/or decreased data throughput in a wireless network.

CLAS may include a network node selecting an uplink antenna configuration for a UE based at least in part on uplink signaling between a UE and a network node. For instance, the network node may select an uplink antenna configuration by reusing an uplink MIMO architecture that is based at least in part on CB uplink MIMO signaling and/or NCB uplink MIMO signaling. However, a network node reusing an uplink MIMO architecture that uses CB uplink MIMO signaling and/or NCB uplink MIMO signaling to perform CLAS may lack flexibility and/or support for various chain-antenna structures. To illustrate, uplink MIMO architecture in combination with CB uplink MIMO signaling for uplink antenna selection may only be used for antenna selection between a limited number of connections, each of which uses a separate reference signal resource (e.g., an SRS resource) for the antenna selection, and the uplink MIMO architecture in combination with NCB uplink MIMO signaling may only allow the network node to perform an uplink antenna selection for a non-coherent antenna selection architecture and/or a fully connected antenna selection architecture, since precoding selection capability (which does not have any selection constraint) is replaced by an antenna selection capability. Alternatively, or additionally, CLAS that uses the uplink MIMO architecture and uplink MIMO signaling may only be applicable to UEs that support fast dynamic antenna switching and/or may not be applicable to UEs that do not support fast dynamic antenna switching. Accordingly, a network node reusing an uplink MIMO architecture and uplink MIMO signaling for uplink antenna selection may not be supported by a wide variety of UEs, resulting in at least some UEs using a sub-optimal uplink antenna configuration, such as an uplink antenna configuration that is based at least in part on assuming reciprocity between an uplink channel and a downlink channel.

As another example of difficulties with CLAS, the individual components of the uplink transmit power matrix P (e.g., P₀ to Pₚ₋₁) and/or a maximum transmit power for each transmit antenna at a UE may be unknown to a network node. Alternatively, or additionally, each transmit antenna at the UE may be subject to a specific absorption rate (SAR) regulatory operating condition and/or maximum power reduction (MPR) regulatory operating conditions. Accordingly, a network node may lack sufficient information to select an antenna configuration at the UE that achieves a maximum transmit power for each transmit antenna, resulting in the network node selecting a sub-optimal antenna configuration. A sub-optimal antenna configuration may lead to decreased signal quality that results in increased recovery errors, increased data transfer delays, and/or decreased data throughput in a wireless network.

However, CLAS may include a network node using signals (e.g., SRSs) transmitted by the UE as part of the CLAS operation (e.g., the network node may measure one or more SRSs to obtain measurement information and select an antenna configuration for the UE based on the measurement information). However, the UE may transmit the signals (e.g., SRSs) relatively infrequently (e.g., as compared to downlink reference signals from the network node). As a result, CLAS may be associated with slower antenna selection adaptation as compared to open-loop antenna selection by the UE (e.g., CLAS may increase latency associated with adapting or changing the antenna configuration of the UE because of the less frequent uplink signal transmission by the UE). The slower antenna selection adaptation may degrade performance of the UE, such as when channel conditions are changing relatively frequently.

As indicated above, FIG. 6 is provided as an example. Other examples may differ from what is described with regard to FIG. 6.

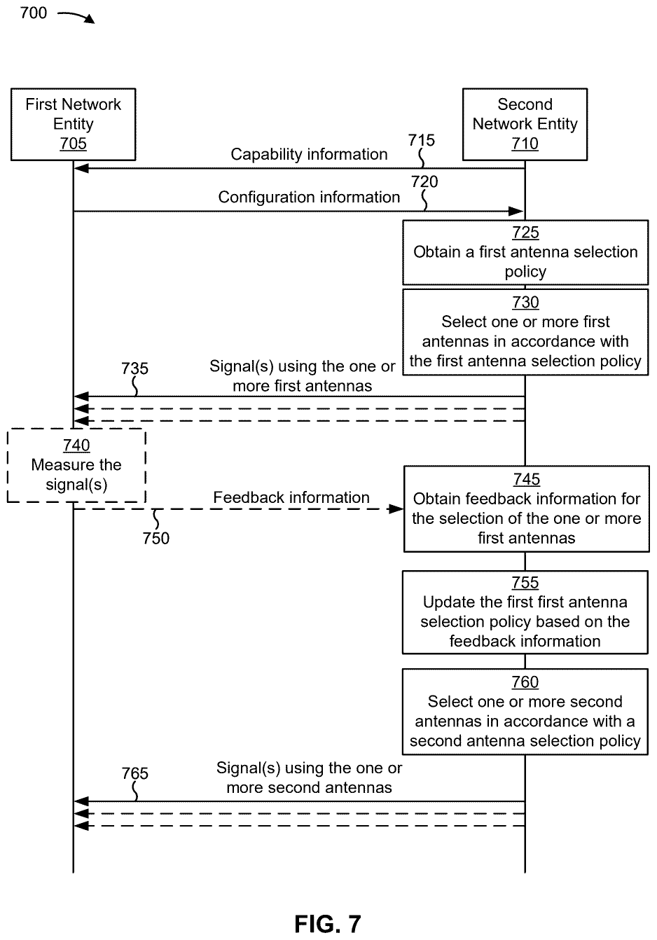

FIG. 7 is a diagram of an example 700 associated with policy updates for antenna selection, in accordance with the present disclosure. As shown in FIG. 7, a first network entity 705 (e.g., the network entity 102, the network entity 104, the network entity 106, the network node 210, a base station, a CU, a DU, and/or an RU) may communicate with a second network entity 710 (e.g., the network entity 102, the network entity 104, the network entity 106, and/or the UE 220). In some aspects, the first network entity 705 and the second network entity 710 may be part of a wireless network (e.g., the wireless communication network 200 or the environment 100). Although antenna selection may be described in some examples herein in the context of uplink (e.g., antenna selection for uplink transmission), the aspects and techniques described herein are similarly applicable for other contexts, such as sidelink and/or downlink, among other examples.

As used herein, the first network entity 705 “outputting” or “transmitting” a communication to the second network entity 710 may refer to a direct transmission (for example, from the first network entity 705 to the second network entity 710) or an indirect transmission via one or more other network nodes or devices, such as one or more TRPs or access nodes. For example, if the first network entity 705 is a DU or an access node controller, an indirect transmission to the second network entity 710 may include the first network entity 705 outputting or transmitting a communication to an RU (e.g., an access node or a TRP) and the RU transmitting the communication to the second network entity 710, or may include causing the RU to transmit the communication (e.g., triggering transmission of a physical layer reference signal). Similarly, the second network entity 710 “transmitting” a communication to the first network entity 705 may refer to a direct transmission (for example, from the second network entity 710 to the first network entity 705) or an indirect transmission via one or more other network nodes or devices, such as one or more TRPs or access nodes. For example, if the first network entity 705 is a DU or an access node controller, an indirect transmission to the first network entity 705 may include the second network entity 710 transmitting a communication to an RU (e.g., a TRP or an access node) and the RU transmitting the communication to the first network entity 705. Similarly, the first network entity 705 “obtaining” or “receiving” a communication may refer to receiving a transmission carrying the communication directly (for example, from the second network entity 710 to the first network entity 705) or receiving the communication (or information derived from reception of the communication) via one or more other network nodes or devices, such as one or more TRPs or access nodes.

Certain aspects and techniques as described herein may be implemented, at least in part, using an AI program, such as a program that includes an ML or ANN model (e.g., an AI/ML model). An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets which may indicate a starting point for outputs of the AI/ML model. An example AI/ML model operating on input data may start at an initial output based on the biases and then update its output based on a combination of the input data and the weights.

In some aspects, an AI/ML model may be configured to provide computing capabilities for wireless communications. Such an AI/ML model may be configured with weights and biases to perform one or more antenna selection operations, such as output probabilities that respective antennas should be selected given certain wireless communication channel conditions. Thus, during operation of the second network entity 710, the AI/ML model may receive input data (such as signal strength measurement information, channel quality measurement information, precoder matrix information, and/or rank information) and make inferences (such as a probability that a given antenna should be selected by the second network entity 710) based on the weights and biases.

AI/ML models may be deployed in one or more devices (for example, network entities) and may be configured to enhance various aspects of a wireless communication system. For example, an AI/ML model may be trained to identify patterns or relationships in data corresponding to a network, a device, and/or an air interface, among other examples. An AI/ML model may support operational decisions relating to one or more aspects associated with wireless communications devices, networks, or services. For example, an AI/ML model may be utilized for supporting or improving aspects, such as antenna selection, signal coding/decoding, network routing, energy conservation, transceiver circuitry controls, frequency synchronization, timing synchronization, channel state estimation, channel equalization, channel state feedback, modulation, demodulation, device positioning, beamforming, load balancing, operations and management functions, and/or security, among other examples.

AI/ML models may be characterized in terms of types of learning that generate specific types of learned models that perform specific types of tasks. For example, different types of machine learning include supervised learning, unsupervised learning, semi-supervised learning, and/or reinforcement learning, among other examples. AI/ML models may be used to perform different tasks such as classification or regression, where classification refers to determining one or more discrete output values from a set of predefined output values, and regression refers to determining continuous values which are not bounded by predefined output values. A regression ML model configured according to embodiments of this disclosure may produce an output which includes probabilities that respective antennas should be selected by the second network entity 710. Some example AI/ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and/or probabilistic graphical models (such as a Bayesian network), among other examples.

The description herein illustrates, by way of some examples, how one or more tasks or problems in wireless communications may benefit from the application of one or more AI/ML models to improve antenna selection by the second network entity 710. To facilitate the discussion, an AI/ML model configured using an ANN is used, but other types of AI/ML models can be used instead of an ANN. Hence, unless expressly recited, subject matter regarding an AI/ML model is not necessarily intended to be limited to an ANN solution. Further, unless otherwise specifically stated, terms such “AI/ML model,” “ML model,” “trained ML model,” “ANN,” “model,” and/or “algorithm,” among other examples, are intended to be interchangeable.

In some aspects, the second network entity 710 may access the AI/ML model that is configured to perform antenna selection. The AI/ML model may include a neural network model. In some aspects, the AI/ML model may be similar to the model(s) described in connection with FIGS. 2, 4, and 5. In some aspects, the AI/ML model may be deployed at the second network entity 710. For example, the second network entity 710 may host the AI/ML model (such as by using a processing system of the second network entity 710). For example, the second network entity 710 may be similar to (and/or may include) the device 265 and/or the model inference host 504. In other aspects, the AI/ML model may be deployed externally from the second network entity 710. In such examples, the second network entity 710 may be configured to communicate with one or more other devices or entities to provide input(s) to the AI/ML model and/or obtain output(s) from the AI/ML model. For example, another device (e.g., the device 265 and/or the model inference host 504) may host the AI/ML model and may communicate with the second network entity 710 to provide input(s) to the AI/ML model and/or obtain output(s) from the AI/ML model for the second network entity 710. For example, the AI/ML model may be hosted at a server device, at a network node (e.g., a network node 210), and/or in a cloud deployment, among other examples. Therefore, as used herein, the second network entity 710 “providing” information to the AI/ML model may refer to the second network entity 710 providing information from a first component of the second network entity 710 to a second component of the second network entity 710 (e.g., internally, where the second component is configured to host the AI/ML model) or may refer to the second network entity 710 transmitting (e.g., in an over-the-air signal or another signal) the information to another device that hosts the AI/ML model. Similarly, the second network entity 710 “obtaining” information from the AI/ML model may refer to the second network entity 710 obtaining information from the second component of the second network entity 710 (e.g., internally, where the second component is configured to host the AI/ML model) or may refer to the second network entity 710 receiving (e.g., in an over-the-air signal or another signal) the information from another device that hosts the AI/ML model.

In some aspects, as shown by reference number 715, the second network entity 710 may optionally transmit, and the first network entity 705 may receive, capability information. The capability information may be included in a capability report. The second network entity 710 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a sidelink channel (e.g., a physical sidelink control channel (PSCCH), and/or a physical sidelink shared channel (PSSCH)), among other examples. The capability information may indicate one or more parameters associated with respective capabilities of the second network entity 710. The one or more parameters may be indicated via respective IEs included in a capability report.

The capability information may indicate whether the second network entity 710 supports a feature and/or one or more parameters related to the feature. For example, the capability information may indicate a capability and/or parameter for supporting MLAS. In some aspects, the capability information may indicate that the second network entity 710 supports performing antenna selection in accordance with an antenna selection policy. In some examples, the capability information may indicate that the second network entity 710 supports using an AI/ML model for antenna selection. One or more operations described herein may be based on capability information. For example, the second network entity 710 may perform a communication in accordance with the capability information, or may receive configuration information that is in accordance with the capability information.

The first network entity 705 may determine configuration information (e.g., an antenna selection configuration) based on, using, or otherwise associated with the capability information. In other examples, the first network entity 705 may determine the configuration information without, or independently of, the capability information. For example, the first network entity 705 may determine that the second network entity 710 supports MLAS as described herein based on a type, category, or other classification of the second network entity 710.

As shown by reference number 720, the first network entity 705 may transmit, and the second network entity 710 may receive, configuration information. In some aspects, the second network entity 710 may receive the configuration information via one or more of system information signaling (e.g., a master information block (MIB) and/or a SIB, among other examples), RRC signaling, MAC signaling (e.g., one or more MAC-CEs), and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may indicate a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some examples, the configuration information may not be expressly signaled to the second network entity 710. For example, in some aspects, the configuration information may at least partially be defined by a wireless communication standard, such as the 3GPP. In such examples, the first network entity 705 may not explicitly indicate such configuration information to the second network entity 710. For example, the second network entity 710 may optionally obtain at least a portion of the configuration information from a configuration stored by the second network entity 710 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate that the second network entity 710 is to perform MLAS, as described herein. For example, the configuration information may indicate that the second network entity 710 is to select one or more antennas in accordance with an antenna selection policy. The antenna selection policy may be for an AI/ML model (e.g., for an antenna selection function of the AI/ML model). In some aspects, the AI/ML model may be trained (e.g., offline) to generate an initial antenna selection policy. The configuration information may indicate that the second network entity 710 is to use the initial antenna selection policy. The configuration information may indicate that the second network entity 710 is to update (e.g., refine) the antenna selection policy using downlink measurement information and/or uplink measurement information (e.g., as described in more detail elsewhere herein).

In some aspects, the configuration information may include one or more downlink reference signal configurations. The one or more downlink reference signal configurations may configure one or more downlink reference signals to be measured by the second network entity 710 for antenna selection. For example, the second network entity 710 may be configured to measure (e.g., using one or more antennas of the second network entity 710) an RSRP and/or another signal parameter of the downlink reference signal(s). The downlink reference signals may be SSBs, CSI-RSs, and/or other types of downlink reference signals.

In some aspects, the configuration information may include one or more uplink reference signal configurations. For example, the second network entity 710 may be configured with one or more SRS resource sets to allocate resources for SRS transmissions by the second network entity 710. For example, a configuration for SRS resource sets may be indicated in an RRC message (e.g., an RRC configuration message or an RRC reconfiguration message). An SRS resource set may include one or more resources (e.g., shown as SRS resources), which may include time resources and/or frequency resources (e.g., a slot, a symbol, a resource block, and/or a periodicity for the time resources). An SRS resource may include one or more antenna ports on which an SRS is to be transmitted (e.g., in a time-frequency resource). Thus, a configuration for an SRS resource set may indicate one or more time-frequency resources in which an SRS is to be transmitted and may indicate one or more antenna ports on which the SRS is to be transmitted in those time-frequency resources. In some aspects, the configuration for an SRS resource set may indicate a use case (e.g., in an SRS-SetUse information element) for the SRS resource set. For example, an SRS resource set may have a use case of antenna selection.

An antenna selection SRS resource set may be used to operate CLAS. For example, when there is CLAS operation between the first network entity and the second network entity, a network node 210 may use an antenna selection SRS (e.g., an SRS transmitted using a resource of an antenna selection SRS resource set) to acquire uplink channel measurements (e.g., to derive uplink measurement information or to determine candidate antennas to be used for uplink transmission).

An SRS resource can be configured as periodic, semi-persistent (sometimes referred to as semi-persistent scheduling (SPS)), or aperiodic. A periodic SRS resource may be configured via a configuration message that indicates a periodicity of the SRS resource (e.g., a slot-level periodicity, where the SRS resources occurs every Y slots) and a slot offset. In some cases, a periodic SRS resource may always be activated, and may not be dynamically activated or deactivated. A semi-persistent SRS resource may also be configured via a configuration message that indicates a periodicity and a slot offset for the semi-persistent SRS resource, and may be dynamically activated and deactivated (e.g., using DCI or a MAC-CE). An aperiodic SRS resource may be triggered dynamically, such as via DCI (e.g., UE-specific DCI or group common DCI) or a MAC-CE.

In some aspects, the second network entity 710 may be configured with a mapping between SRS ports (e.g., antenna ports) and corresponding SRS resources. The second network entity 710 may transmit an SRS on a particular SRS resource using an SRS port indicated in the configuration. In some aspects, an SRS resource may span N adjacent symbols within a slot (e.g., where N equals 1, 2, 4, or another integer). The second network entity 710 may be configured with X SRS ports (e.g., where X≤4). In some aspects, each of the X SRS ports may be mapped to a corresponding symbol of the SRS resource and used for transmission of an SRS in that symbol. The second network entity 710 may be configured to transmit the SRS(s) to enable the first network entity 710 to obtain uplink measurement information (e.g., to evaluate an antenna selection performed by the second network entity 710).

As shown by reference number 725, the second network entity 710 may obtain a first antenna selection policy. The first antenna selection policy may be an initial antenna selection policy. The initial antenna selection policy may be based on an antenna selection scheme. For example, the second network entity 710 may learn the initial antenna selection policy for an AI/ML model based on one or more non-AI/ML antenna selection schemes. For example, the antenna selection scheme may not use AI/ML for antenna selection.

In some aspects, the antenna selection scheme may be a fixed antenna scheme (e.g., where the initial antenna selection policy indicates which antenna(s) are to be used for transmission in a fixed manner). In some other aspects, the antenna selection scheme may be a joint antenna selection and singular value decomposition (SVD) precoding scheme. In some other aspects, the antenna selection scheme may be a joint antenna selection and codebook-based precoding scheme (e.g., where the codebook-based precoding scheme is based on a set of pre-defined precoding matrices to be stored both network entities). In some other aspects, the antenna selection scheme may be an antenna selection scheme using uplink measurement information (e.g., uplink RSRP). In some other aspects, the antenna selection scheme may be an antenna selection scheme using downlink measurement information (e.g., downlink RSRP). In some other aspects, the antenna selection scheme may be an antenna selection scheme using long-term mutual information (e.g., where long-term mutual information can be calculated based on time-averaged uplink channel matrix). In some other aspects, the antenna selection scheme may be an antenna selection scheme taking into account both measurement information and antenna correction.

The AI/ML model may be trained offline to generate an initial probability vector based on the antenna selection scheme. In some aspects, the AI/ML model may be refined based on simulation data and/or other data. The second network entity 710 may initialize the antenna selection policy of the AI/ML model to the initial (or first) antenna selection policy.

As shown by reference number 730, the second network entity 710 may select one or more first antennas in accordance with the first antenna selection policy. Selecting antenna(s) “in accordance with an antenna selection policy” may refer to the second network entity 710 selecting one or more antennas using a probability distribution indicated by the antenna selection policy. For example, a function of an AI/ML model may include a policy function that obtains a state (e.g., measurement information and/or other information) and outputs a probability distribution for respective actions. In such examples, the actions may include the selection of respective sets of one or more antennas of the second network entity 710.

For example, the second network entity 710 may provide, to the AI/ML model, measurement information (e.g., where the AI/ML model is configured with, or trained using, the first antenna selection policy). The measurement information may include measurement information obtained, generated, and/or determined by the second network entity 710. For example, the second network entity 710 may measure one or more signals, such as signal(s) transmitted by the first network entity 705, to obtain the measurement information. The second network entity 710 may measure the one or more signals using multiple (or all) antennas of the second network entity 710. For example, the measurement information may include measurement values corresponding to respective antennas of the second network entity 710. In some aspects, the measurement information may be downlink measurement information. The measurement information may indicate one or more signal parameter values, such as RSRP values, RSRQ values, SNR values, and/or other signal parameter values.

The AI/ML model may process the measurement information as input information (or input data). The AI/ML model may provide an output for antenna selection based on the measurement information. For example, the second network entity 710 may obtain, from the AI/ML model, an output that is indicative of the one or more first antennas to be selected by the second network entity 710. The output may be in accordance with the first antenna selection policy (e.g., in that the AI/ML model produced the output based on being configured or trained with the first antenna selection policy). The output may include a probability distribution. The probability distribution may indicate probabilities for respective antennas of the second network entity 710. A probability may indicate a likelihood that the second network entity 710 is to select a given antenna (e.g., given the measurement information provided as input data and/or other criteria configured for the AI/ML model, such as implementation aspects or RF component design considerations of the second network entity 710). A higher probability may indicate that it is more likely that the second network entity 710 should select a given antenna, whereas a lower probability may indicate that it is less likely that the second network entity 710 should select the given antenna. For example, the probability distribution may indicate that the one or more first antennas have the highest probabilities to be selected by the second network entity 710.

As shown by reference number 735, the second network entity 710 may transmit one or more signals using the one or more first antennas (e.g., selected as described in connection with reference number 730). For example, the second network entity 710 may transmit, and the first network entity 705 may receive, the one or more signals. The one or more signals may be uplink signals, downlink signals, sidelink signals, reference signals (e.g., SRSs), data channel signals, control channel signals, and/or other types of signals. In some aspects, the one or more signals may be uplink data channel signals (e.g., PUSCH signals). In some aspects, the second network entity 710 may transmit the one or more signals in accordance with the configuration information. For example, the one or more signals may be reference signals, such as SRSs. The second network entity 710 may transmit the one or more reference signals using resources (e.g., time domain resources and/or frequency domain resources) indicated by the configuration information, such as an SRS configuration. In some aspects, the resources may be associated with (or correspond to) antenna ports for the one or more first antennas (e.g., to enable the first network entity 710 to identify which SRS(s) are transmitted using different antennas of the second network entity 710).

For example, the second network entity 710 may configure an RF front end and/or a processing system of the second network entity 710 to cause the signal(s) to be transmitted via the one or more first antennas. For example, the second network entity 710 may switch one or more selected antenna(s) to be the one or more first antennas based on the selection of the one or more first antennas.

In some aspects, as shown by reference number 740, the first network entity 705 may measure the one or more signals to obtain measurement information. The measurement information may be uplink measurement information. The measurement information may indicate one or more signal parameter values, such as RSRP values, RSRQ values, SNR values, and/or other signal parameter values. In some aspects, the measurement information may include one or more uplink SRS RSRP values.

As shown by reference number 745, the second network entity 710 may obtain feedback information for the selection of the one or more first antennas. The feedback information may indicate whether a first antenna selection (e.g., the one or more first antennas) or a second antenna selection (e.g., a previous antenna selection or another antenna selection) has better performance. For example, the feedback information may be indicative of a first performance level of the one or more first antennas. The first performance level may be based on a throughput level (e.g., an average transmitted throughput), measurement information (e.g., the measurement information obtained by the first network entity 705 as described in connection with reference number 740), and/or reliability information (e.g., HARQ feedback information), among other examples.

In some aspects, the second network entity 710 obtaining the feedback information may include the second network entity 710 measuring one or more metrics. For example, the feedback information may include throughput information. The second network entity 710 may measure (or determine) the throughput information based on an amount of data transmitted using the one or more first antennas (e.g., via the one or more signals transmitted as described in connection with reference number 735) over a given period of time. The throughput information may indicate one or more throughput levels for the one or more first antennas. The throughput information may be first throughput information. Second throughput information may indicate one or more throughput levels for the second antenna selection (e.g., a previous antenna selection of different antenna(s)). The second network entity 710 may compare the first throughput information to the second throughput information to determine whether the first antenna selection or the second antenna selection has better performance. For example, if the comparison indicates that throughput level(s) (e.g., an average transmitted throughput) are higher for the first antenna selection (e.g., for the one or more first antennas), then the second network entity 710 may determine that the first antenna selection has better performance than the second antenna selection. If the comparison indicates that throughput level(s) (e.g., an average transmitted throughput) are lower for the first antenna selection (e.g., for the one or more first antennas), then the second network entity 710 may determine that the second antenna selection has better performance than the first antenna selection.

Additionally, or alternatively, as shown by reference number 750, the second network entity 710 obtaining the feedback information may include the first network entity 705 transmitting, and the second network entity 710 receiving, at least a portion of the feedback information. The first network entity 705 may transmit, and the second network entity 710 may receive, the feedback information via MAC signaling (e.g., one or more MAC-CEs), and/or physical layer signaling (e.g., one or more control channel communications (e.g., one or more PDCCH communications) and/or DCI), among other examples.

In some aspects, the second network entity 710 may transmit, and the first network entity 705 may receive, one or more antenna selection results. As used herein, “antenna selection result” refers to a selection of one or more antennas, such as by the second network entity 710. For example, the second network entity 710 may transmit, and the first network entity 705 may receive, an indication of one or more antennas (e.g., the one or more first antennas) that have been selected by the first network entity 710. The second network entity 710 may transmit, and the first network entity 705 may receive, the antenna selection results periodically and/or based on the second network entity 710 selecting new antenna(s) (e.g., the second network entity 710 may transmit an indication of an antenna selection result based on the antenna selection result being associated with a change in the antenna(s) used by the second network entity 710). The second network entity 710 may indicate an antenna selection result by transmitting one or more indices (e.g., antenna port indices and/or SRS port indices) for respective antennas selected as part of the antenna selection result. The second network entity 710 may transmit, and the first network entity 705 may receive, an antenna selection result via MAC signaling (e.g., one or more MAC-CEs), and/or physical layer signaling (e.g., one or more control channel communications (e.g., one or more PUCCH communications) and/or UCI), among other examples.

In some aspects, the feedback information from the first network entity 705 may include an indication of one or more (e.g., S) antenna selection results associated with the best performance (e.g., as measured or determined by the first network entity 705). The first network entity 705 may indicate the one or more (e.g., S) antenna selection results by indicating respective SRS resources (e.g., SRS resource identifiers) associated with the one or more (e.g., S) antenna selection results. For example, as described elsewhere herein, the second network entity 710 may transmit (e.g., in a periodic, semi-persistent, and/or aperiodic manner) SRSs using different antennas (e.g., selected by the second network entity 710 as described herein, such as by using the AI/ML model). As described in connection with reference number 740, the first network entity 705 may measure the SRS(s) transmitted by the second network entity 710 to obtain measurement information. The first network entity 705 may determine the one or more (e.g., S) antenna selection results based on the measurement information. For example, the one or more (e.g., S) antenna selection results may be SRS(s) associated with the highest measurement values as indicated by the measurement information.

In such examples, the second network entity 710 may compare the one or more (e.g., S) antenna selection results indicated by the first network entity 705 to one or more (e.g., D) antenna selection results that were determined as having the best performance by the second network entity 710 (e.g., using throughput information, for example, as described in more detail elsewhere herein). If the S antenna selection results and the D antenna selection results match (e.g., if the S antenna selection results and the D antenna selection results include the same one or more antenna selection results), then the second network entity 710 may determine that the antenna selection policy (e.g., the first antenna selection policy) does not need to be updated. If the S antenna selection results and the D antenna selection results do not match (e.g., if the S antenna selection results and the D antenna selection results include different antenna selection results), then the second network entity 710 may determine that the antenna selection policy (e.g., the first antenna selection policy) should be updated. In such examples, the second network entity 710 may determine that the S antenna selection results are associated with the best performance (or highest performance level) when updating the antenna selection policy, as described in more detail elsewhere herein, such as in connection with reference number 755).

Additionally, or alternatively, the feedback information from the first network entity 705 may indicate whether the first antenna selection result (e.g., the one or more first antennas) or the second antenna selection result (e.g., a previous antenna selection result made by the second network entity 710) has better performance. For example, the first network entity 705 may determine whether the first antenna selection result or the second antenna selection result has better performance based on receiving an indication from the second network entity 710 that the second network entity 710 has switched from the second antenna selection result to the first antenna selection result. As described in connection with reference number 740, the first network entity 705 may measure the SRS(s) transmitted by the second network entity 710 to obtain measurement information. The first network entity 705 may determine whether the first antenna selection result or the second antenna selection result has better performance based on the measurement information. For example, if first SRS measurement information (e.g., obtained while the second network entity 710 is using the one or more first antennas) indicates higher or better measurements than second SRS measurement information (e.g., obtained while the second network entity 710 is using one or more other antennas associated with the second antenna selection result), then the first network entity 705 may determine that the first antenna selection result has better performance. If the first SRS measurement information indicates lower or worse measurements than the second SRS measurement information, then the first network entity 705 may determine that the second antenna selection result has better performance.

In such examples, the second network entity 710 may determine whether the first antenna selection result or the second antenna selection result has better performance based on the throughput information and/or other information, as described in more detail elsewhere herein. The second network entity 710 may determine whether the antenna selection result (e.g., the first antenna selection result or the second antenna selection result) determined as being the best by the second network entity 710 is the same as the antenna selection result determined as being the best by the first network entity 705. If the first network entity 705 and the second network entity 710 determine that the same antenna selection result (e.g., the first antenna selection result or the second antenna selection result) has the best performance, then the second network entity 710 may determine that the antenna selection policy (e.g., the first antenna selection policy) does not need to be updated. If the first network entity 705 and the second network entity 710 determine that different antenna selection results (e.g., the first antenna selection result or the second antenna selection result) have the best performance, then the second network entity 710 may determine that the antenna selection policy (e.g., the first antenna selection policy) should be updated. In such examples, the second network entity 710 may determine that the antenna selection result (e.g., the first antenna selection result or the second antenna selection result) indicated by the first network entity 705 as having the best performance does have the best performance when updating the antenna selection policy (e.g., as described in more detail elsewhere herein, such as in connection with reference number 755).

Additionally, or alternatively, the feedback information from the first network entity 705 may include measurement information (e.g., the measurement information obtained by the first network entity 705 as described in connection with reference number 740). For example, the first network entity 705 may transmit, and the second network entity 710 may receive, a measurement report (e.g., an SRS measurement report) that includes the measurement information (e.g., one or more SRS measurement values, such as one or more SRS RSRP values). In such examples, the second network entity 710 may select one or more antennas (e.g., to determine the second antenna selection result) based on the measurement information provided by the first network entity 705. For example, the second antenna selection result may be an uplink-based antenna selection result (e.g., if the measurement information provided by the first network entity 705 is uplink measurement information). In such examples, the first antenna selection result (e.g., the selection of the one or more first antennas) may be a downlink-based antenna selection result (e.g., if the measurement information used by the second network entity 710, as described in connection with reference number 730, is downlink measurement information).

In such examples, the second network entity 710 may compare the first antenna selection result (e.g., the downlink-based antenna selection result) to the second antenna selection result (e.g., the uplink-based antenna selection result). If the comparison indicates that the first antenna selection result and the second antenna selection result both indicate that the same antenna(s) (e.g., the one or more first antennas) are to be selected, then the second network entity 710 may determine that the antenna selection policy (e.g., the first antenna selection policy) does not need to be updated. If the comparison indicates that the first antenna selection result and the second antenna selection result indicate that different antenna(s) are to be selected, then the second network entity 710 may determine that the antenna selection policy (e.g., the first antenna selection policy) should be updated. In such examples, the second network entity 710 may determine that the second antenna selection result (e.g., the uplink-based antenna selection result) has better performance when updating the antenna selection policy (e.g., because the second antenna selection result is based on measurement information obtained by the first network entity 705 and may not be impacted by effects of channel reciprocity errors).

In some aspects, the feedback information may include HARQ feedback for the one or more signals (e.g., transmitted as described in connection with reference number 735), such as one or more ACK indications or NACK indications. The HARQ feedback may be indicative of a reliability level of the signal(s) transmitted by the second network entity 710 using the selected antenna(s) (e.g., the one or more first antennas). The second network entity 710 may determine a first reliability level for the first antenna selection result (e.g., the selection of the one or more first antennas) based on the HARQ feedback. A reliability level may include an ACK rate (e.g., a rate or percentage of signals for which an ACK indication was received) and/or a NACK rate (e.g., a rate or percentage of signals for which a NACK indication was received). The second network entity 710 may compare the first reliability level to a second reliability level associated with the second antenna selection result (e.g., a previous antenna selection result). If the first reliability level indicates a higher reliability than the second reliability level (e.g., a higher ACK rate or a lower NACK rate), then the second network entity 710 may determine that the first antenna selection result has better performance. If the first reliability level indicates a lower reliability than the second reliability level (e.g., a lower ACK rate or a higher NACK rate), then the second network entity 710 may determine that the second antenna selection result has better performance.

In some aspects, the feedback information may include transmit power information. For example, the first network entity 705 may transmit, and the second network entity 710 may receive, the transmit power information. The transmit power information may indicate a transmit power to be used by the second network entity 710. For example, the transmit power information may include a transmit power command and/or an offset to be applied to the transmit power, among other examples. The transmit power information may be indicative of the performance level of the antenna selection result(s). For example, if the transmit power information indicates that the second network entity 710 is to increase the transmit power when using antenna(s) selected as part of a given antenna selection result, then the second network entity 710 may determine that the given antenna selection result has a lower performance level (e.g., because the increased transmit power consumes additional power of the second network entity 710 and/or may be indicative of poor reception performance at the first network entity 705). If the transmit power information indicates that the second network entity 710 is to decrease the transmit power when using antenna(s) selected as part of a given antenna selection result, then the second network entity 710 may determine that the given antenna selection result has a higher performance level because the decreased transmit power enables power saving for the second network entity 710 and/or may be indicative of increased reception performance at the first network entity 705).

As shown by reference number 755, the second network entity 710 may update the antenna selection policy (e.g., the first antenna selection policy) based on the feedback information. For example, the second network entity 710 may determine a second antenna selection policy based on the feedback information and the first antenna selection policy. For example, the second network entity 710 may determine, based on the feedback information, performance level information indicative of whether the first performance level (e.g., of the first antenna selection result described in connection with reference number 730) is greater than a second performance level associated with a previous antenna selection (e.g., the second antenna selection result described herein). The second network entity 710 may determine, based on the performance level information, the second antenna selection policy.

In some aspects, the second network entity 710 may update the antenna selection policy using a loss function. For example, the loss function may be based on a reinforcement learning framework (e.g., a reinforcement learning with human feedback (RLHF) framework) where the feedback information described herein is provided as a reward or penalty for the output of the AI/ML model. The loss function may be configured to minimize the error probability (or maximize the negative of the error probability) of the antenna selection policy based on the feedback information. For example, a DPO framework may be used to represent the antenna selection policy in terms of a reward function (e.g., the feedback information).

The loss function may be represented as

$${ℒ}_{DPO} ( {π}_{θ} ; {π}_{ref} ) = - {𝔼}_{( c , {y}_{w} , {y}_{l} )} [ log σ ( log \frac{{π}_{θ} ( {y}_{w} \vert c )}{{π}_{ref} ( {y}_{w} \vert c )} - log \frac{{π}_{θ} ( {y}_{l} \vert c )}{{π}_{ref} ( {y}_{l} \vert c )} ) ]$$

where [symbol] _{DPO}(π_{θ}; π_{ref}) is the DPO loss function for an antenna selection policy being trained (e.g., π_{θ} or the second antenna selection policy) and a reference antenna selection policy (e.g., π_{ref} or the first antenna selection policy). σ(⋅) represents the logistic function (or sigmoid). [symbol] _{(c,y}_{_{w}}_{,y}_{ₗ}₎ represents the expectation under the distribution of the tuple (c, y_{w}, yₗ), and

$$σ ( log \frac{{π}_{θ} ( {y}_{w} \vert c )}{{π}_{ref} ( {y}_{w} \vert c )} - log \frac{{π}_{θ} ( {y}_{l} \vert c )}{{π}_{ref} ( {y}_{l} \vert c )} )$$

may be the probability of the policy π_{θ} choosing y_{w} over yₗ, given a context c (e.g., measurement information, such as the measurement information obtained by the second network entity 710 and/or the measurement information obtained by the first network entity 705 as described in connection with reference number 740), a “winning” (better) antenna selection result y_{w} (e.g., the antenna selection result (the first antenna selection result or the second antenna selection result) determined to be associated with the better performance, as described in more detail elsewhere herein), and a “losing” (worse) antenna selection result yₗ (e.g., the antenna selection result (the first antenna selection result or the second antenna selection result) determined to be associated with worse performance, as described in more detail elsewhere herein). Hence, [symbol] _{DPO}(π_{θ}; π_{ref}) is the binary cross entropy loss, and minimizing [symbol] _{DPO}(π_{θ}; π_{ref}) may result in reduced probability of incorrectly choosing yₗ over y_{w}, given the context c, (or “error rate”)

For example, the second network entity 710 may determine, using the loss function, the second antenna selection policy (e.g., π_{θ}) based on the performance level information and the first antenna selection policy. For example, the second network entity 710 determine the “winning” antenna selection result y_{w} and the “losing” antenna selection result yₗ based on the feedback information as described elsewhere herein. The second network entity 710 may determine the second antenna selection policy (e.g., π_{θ}) using the AI/ML model (e.g., by providing the “winning” antenna selection result y_{w} and the “losing” antenna selection result y and the measurement information as the context c as input to the AI/ML model). For example, the second network entity 710 may update the second antenna selection policy (e.g., π_{θ}) to minimize the loss function [symbol] _{DPO}(π_{θ}; π_{ref}), resulting in a reduced error rate for the output of the AI/ML model.

In some aspects, the second network entity 710 may transmit, based on the feedback information, the AI/ML model to obtain the second antenna selection policy. For example, the second network entity 710 may train the AI/ML model using the loss function, as described above. This reduces the complexity associated with updating and/or refining the antenna selection policy as the second antenna selection policy (e.g., π_{θ}) can be determined directly from the feedback information (e.g., by assigning a “winning” and “losing” antenna selection result based on the feedback information) without having to retrain the weights and/or biases of the AI/ML model. The second network entity 710 may configure the AI/ML model to use the second antenna selection policy (e.g., π_{θ}).

As shown by reference number 760, the second network entity 710 may select one or more second antennas. The second network entity 710 may select the one or more second antennas in accordance with the second antenna selection policy. The second network entity 710 may select the one or second antennas in a similar manner as described in connection with reference number 730, but using the second antenna selection policy rather than the first antenna selection policy.

For example, the second network entity 710 may provide, to the AI/ML model, measurement information (e.g., where the AI/ML model is configured with, or trained using, the second antenna selection policy). The measurement information may include measurement information obtained, generated, and/or determined by the second network entity 710. For example, the second network entity 710 may measure one or more signals, such as signal(s) transmitted by the first network entity 705, to obtain the measurement information. The second network entity 710 may measure the one or more signals using multiple (or all) antennas of the second network entity 710. For example, the measurement information may include measurement values corresponding to respective antennas of the second network entity 710. In some aspects, the measurement information may be downlink measurement information. The measurement information may indicate one or more signal parameter values, such as RSRP values, RSRQ values, SNR values, and/or other signal parameter values.

The AI/ML model may process the measurement information as input information (or input data). The AI/ML model may provide an output for antenna selection based on the measurement information. For example, the second network entity 710 may obtain, from the AI/ML model, an output that is indicative of the one or more second antennas to be selected by the second network entity 710. The output may be in accordance with the second antenna selection policy (e.g., in that the AI/ML model produced the output based on being configured or trained with the second antenna selection policy). The output may include a probability distribution. The probability distribution may indicate probabilities for respective antennas of the second network entity 710. For example, the probability distribution may indicate that the one or more second antennas have the highest probabilities to be selected by the second network entity 710. As shown by reference number 765, the second network entity 710 may transmit one or more signals using the one or more second antennas (e.g., selected as described in connection with reference number 760).

By the second network entity 710 selecting the one or more second antennas in accordance with the second antenna selection policy, the antenna selection result may be improved. For example, the second network entity 710 may improve the performance of the antenna selection policy based on open-loop feedback information (e.g., the throughput information described herein) for increased antenna selection adaptation rates (e.g., to enable the second network entity 710 to quickly update and/or refine the antenna selection policy based on changing channel conditions (e.g., as indicated by the throughput information). Additionally, the second network entity 710 may improve the performance of the antenna selection policy based on closed-loop feedback information (e.g., the feedback information received from the first network entity 705, such as described in connection with reference number 750). The closed-loop feedback information may enable the second network entity 710 to update and/or refine the antenna selection policy to account for channel reciprocity errors (e.g., that may be reflected in the measurement information input by the second network entity 710 to the AI/ML model).

The second network entity 710 may repeat one or more operations described herein over time to update and/or refine the antenna selection policy (e.g., until the antenna selection policy has converged). For example, in some aspects, the second network entity 710 may determine convergence information for the antenna selection policy and/or for the AI/ML model. The convergence information may indicate whether the antenna selection policy for the AI/ML model has converged. For example, the second network entity 710 may determine that a change in a value of the loss function between different antenna selections satisfies a convergence threshold. For example, if the value of the loss function remains relatively stable between antenna selections, this may indicate that the antenna selection policy has converged.

In some aspects, the second network entity 710 may transmit, and the first network entity 705 may receive, request information indicating to stop transmission of a periodic measurement report (e.g., an SRS measurement report) or to reduce a periodicity of the periodic measurement report being transmitted by the first network entity 705. For example, as described elsewhere herein, the first network entity 705 may transmit measurement information (e.g., included in the feedback information described in connection with reference number 750) to enable the second network entity 710 to update and/or refine the antenna selection policy to account for channel reciprocity errors. The second network entity 710 may transmit the request information based on the convergence information indicating that the antenna selection policy has converged. This may conserve network resources that would have otherwise been used to transmit the measurement report (or to transmit the measurement report more frequently) after convergence of the antenna selection policy.

As indicated above, FIG. 7 is provided as an example. Other examples may differ from what is described with regard to FIG. 7.

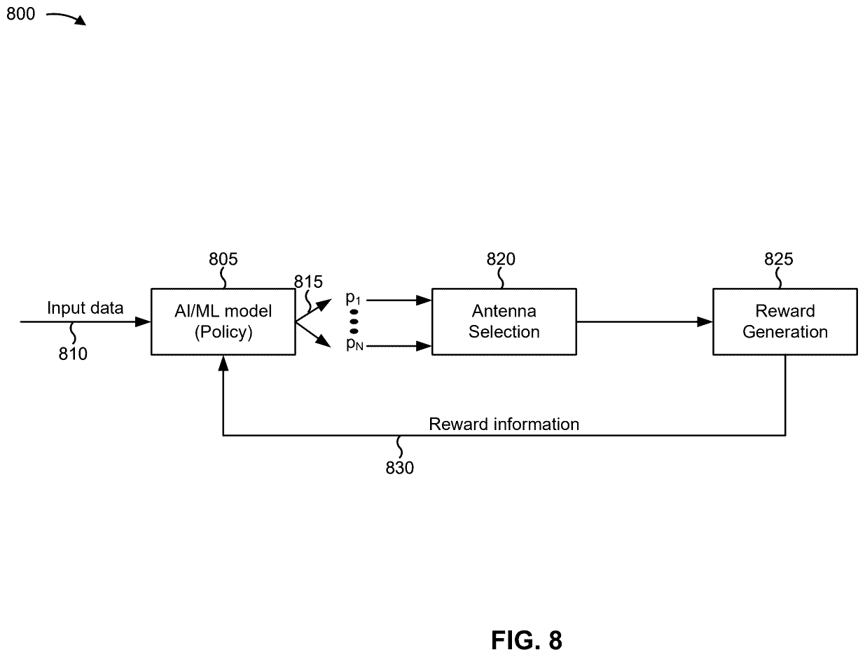

FIG. 8 is a diagram of an example 800 associated with policy updates for antenna selection, in accordance with the present disclosure. As shown in FIG. 8, an AI/ML model 805 may be configured with an antenna selection policy. The antenna selection policy may indicate one or more weights and/or biases of the AI/ML model 805. The AI/ML model 805 may be similar to the AI/ML model(s) described elsewhere herein, such as in connection with FIGS. 4, 5, 7, and 9.

Input data 810 may be provided to the AI/ML model 805. The input data 810 may include measurement information. The measurement information may be similar to the measurement information provided as an input by the second network entity 710, as described in connection with FIG. 7. In some aspects, the measurement information may include downlink measurement information. For example, the measurement information may include downlink measurements performed using respective antennas (e.g., of a network entity, such as the second network entity 710).

The AI/ML model 805 may generate an output 815 based on the input data 810. For example, the AI/ML model 805 may use the antenna selection policy to generate the output 815 based on the input data 810. The output 815 may include a probability distribution indicating probabilities that respective antennas are to be selected. An antenna selection operation 820 may use the output 815 to select one or more antennas. For example, a network entity (e.g., the second network entity 710) may perform the antenna selection operation 820 to select one or more antennas based on the output 815. For example, the antenna selection operation 820 may include the network entity selecting the antenna(s) with the highest probabilities as indicated by the output 815.

A reward generation operation 825 may include the network entity determining a “winner” antenna selection result and a “loser” antenna selection result. For example, the reward generation operation 825 may include the network entity determining information indicative of one or more performance levels of respective antenna selection results. The network entity may perform the reward generation operation 825 based on feedback information, such as the feedback information described in connection with FIG. 7 (and reference numbers 745 and 750). For example, the feedback information may include open-loop feedback information (e.g., throughput information) and/or closed-loop feedback information (e.g., feedback information received from another network entity, such as the first network entity 705). The reward generation operation 825 may result in reward information 830. The reward information 830 may indicate a “winner” antenna selection result and a “loser” antenna selection result, as described in more detail elsewhere herein. The antenna selection policy of the AI/ML model 805 may be updated based on the reward information 830, as described in more detail elsewhere herein.

As indicated above, FIG. 8 is provided as an example. Other examples may differ from what is described with regard to FIG. 8.

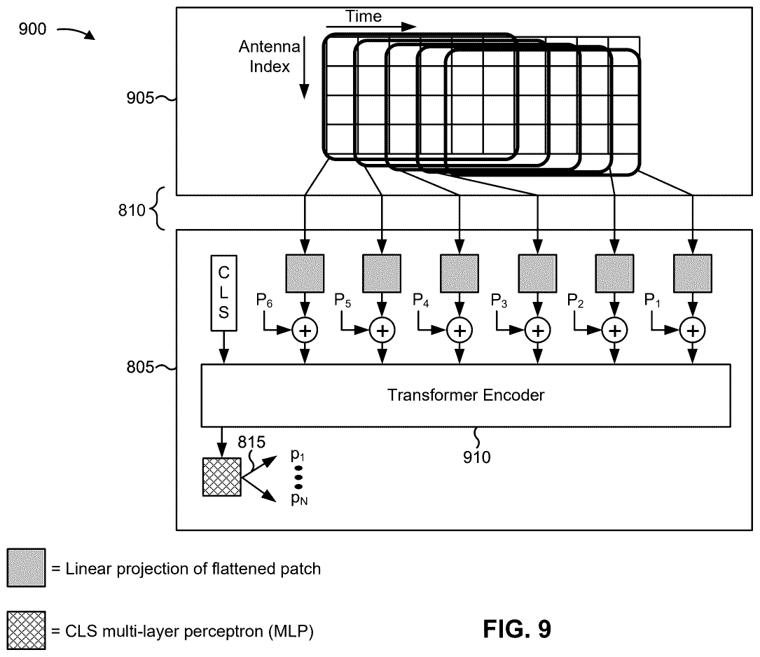

FIG. 9 is a diagram of an example 900 associated with a model architecture for antenna selection, in accordance with the present disclosure.

As shown in FIG. 9, the input data 810 may be provided to the AI/ML model 805, as described elsewhere herein. As shown by reference number 905, the input data 810 may include one or more matrices (e.g., six matrices as shown in FIG. 9 as an example) of measurement values obtained by respective antennas during respective measurement instances (or measurement occasions). For example, each matrix may include measurement information for one or more measurement instances (e.g., over time). The measurement information for each measurement instance may include measurement values obtained using respective antennas (e.g., shown as antenna indices in FIG. 9). As a result, the input data 810 may include per-antenna measurement information for different time windows (e.g., one or more sliding time windows). For example, the input data 810 may include measurement values measured on each of L antennas every V milliseconds over a B millisecond window (e.g., on each of four antennas every 20 milliseconds for the last 200 milliseconds). This enables the input data 810 to capture changing channel conditions over time.

The input data 810 may be provided to the AI/ML model 805 as one or more tokens. A token may include a matrix indicating the measurement information, as described herein. The AI/ML model 805 may project each flattened token using a linear layer (e.g., the common linear is applied to all the tokens). The AI/ML model 805 may add a learnable positional embedding to each of the projected flattened tokens and provide the information to a transformer encoder 910. The positional embeddings are shown in FIG. 9 as P₁ through P₆. The positional embeddings may provide information indicative of an order of the tokens in a sequence, thereby enabling the AI/ML model 805 to maintain relative positions in time associated with the input data 810. Additionally, a classification (CLS) token may be provided to the transformer encoder 910. The CLS token may be used as an aggregate representation of the entire sequence of the input data 810.

The transformer encoder 910 may be configured with an antenna selection policy, as described herein. The transformer encoder 910 may include a neural network (such as an ANN) as described in more detail elsewhere herein. The transformer encoder 910 may include one or more layers of transformer layers. Each transformer layer may include a self-attention layer, an multi-layer perceptron (MLP), and/or normalization layers. As shown in FIG. 9, the output 815 may be indicated by an MLP head, based on or in response to the transformer encoder 910 output embedding corresponding to the CLS token For example, the CLS token and one more tokens corresponding to the input data 810 may be passed through the transformer encoder 910. The MLP head applied to the output embedding corresponding to the CLS token may provide the output 815 (e.g., may output the probability distribution of selecting respective antennas).

As indicated above, FIG. 9 is provided as an example. Other examples may differ from what is described with regard to FIG. 9.

FIG. 10 is a diagram illustrating an example process 1000 performed, for example, at a first network entity or an apparatus of a first network entity, in accordance with the present disclosure. Example process 1000 is an example where the apparatus or the first network entity (e.g., the second network entity 710, the network entity 102, the network entity 106, the UE 220, the actor 508, and/or the subject of action 510) performs operations associated with policy updates for antenna selection.

As shown in FIG. 10, in some aspects, process 1000 may include selecting, in accordance with a first antenna selection policy, one or more first antennas (block 1010). For example, the first network entity (e.g., using communication manager 1206, depicted in FIG. 2) may select, in accordance with a first antenna selection policy, one or more first antennas, as described above.

As further shown in FIG. 10, in some aspects, process 1000 may include transmitting, using the one or more first antennas, one or more first signals (block 1020). For example, the first network entity (e.g., using transmission component 1204 and/or communication manager 1206, depicted in FIG. 12) may transmit, using the one or more first antennas, one or more first signals, as described above.

As further shown in FIG. 10, in some aspects, process 1000 may include obtaining, based on the one or more first signals, feedback information indicative of a first performance level of the one or more first antennas (block 1030). For example, the first network entity (e.g., using reception component 1202 and/or communication manager 1206, depicted in FIG. 12) may obtain, based on the one or more first signals, feedback information indicative of a first performance level of the one or more first antennas, as described above.

As further shown in FIG. 10, in some aspects, process 1000 may include selecting, in accordance with a second antenna selection policy, one or more second antennas, wherein the second antenna selection policy is based on the feedback information (block 1040). For example, the first network entity (e.g., using communication manager 1206, depicted in FIG. 12) may select, in accordance with a second antenna selection policy, one or more second antennas, wherein the second antenna selection policy is based on the feedback information, as described above.

As further shown in FIG. 10, in some aspects, process 1000 may include transmitting, using the one or more second antennas, one or more second signals (block 1050). For example, the first network entity (e.g., using transmission component 1204 and/or communication manager 1206, depicted in FIG. 12) may transmit, using the one or more second antennas, one or more second signals, as described above.

Process 1000 may include additional aspects, such as any single aspect or any combination of aspects described below and/or in connection with one or more other processes described elsewhere herein.

In a first aspect, the first antenna selection policy and the second antenna selection policy are policies for an AI/ML model that is configured to perform antenna selection.

In a second aspect, alone or in combination with the first aspect, selecting the one or more first antennas comprises providing, to the AI/ML model, measurement information, and obtaining, from the AI/ML model, an output that is indicative of the one or more first antennas, wherein the output is in accordance with the first antenna selection policy.

In a third aspect, alone or in combination with one or more of the first and second aspects, selecting the one or more second antennas comprises providing, to the AI/ML model, measurement information, and obtaining, from the AI/ML model, an output that is indicative of the one or more second antennas, wherein the output is in accordance with the second antenna selection policy.

In a fourth aspect, alone or in combination with one or more of the first through third aspects, the AI/ML model includes a neural network model.

In a fifth aspect, alone or in combination with one or more of the first through fourth aspects, process 1000 includes determining, based on the feedback information, performance level information indicative of whether the first performance level is greater than a second performance level associated with a previous antenna selection, and determining, based on the performance level information, the second antenna selection policy.

In a sixth aspect, alone or in combination with one or more of the first through fifth aspects, determining the second antenna selection policy comprises determining, using a loss function, the second antenna selection policy based on the performance level information and the first antenna selection policy.

In a seventh aspect, alone or in combination with one or more of the first through sixth aspects, process 1000 includes training, based on the feedback information, an AI/ML model to obtain the second antenna selection policy.

In an eighth aspect, alone or in combination with one or more of the first through seventh aspects, the feedback information includes an average transmission throughput associated with the one or more first antennas.

In a ninth aspect, alone or in combination with one or more of the first through eighth aspects, obtaining the feedback information includes receiving the feedback information.

In a tenth aspect, alone or in combination with one or more of the first through ninth aspects, receiving the feedback information includes receiving the feedback information from a second network entity.

In an eleventh aspect, alone or in combination with one or more of the first through tenth aspects, the feedback information includes one or more antenna selection results from a set of antenna selection results, wherein the one or more antenna selection results are associated with one or more highest performance levels, wherein the one or more first antennas are associated with an antenna selection result from the set of antenna selection results.

In a twelfth aspect, alone or in combination with one or more of the first through eleventh aspects, the feedback information indicates whether the first performance level is greater than a second performance level associated with a previously performed antenna selection operation.

In a thirteenth aspect, alone or in combination with one or more of the first through twelfth aspects, the feedback information includes measurement information associated with the one or more first signals, wherein the first performance level is based on the measurement information.

In a fourteenth aspect, alone or in combination with one or more of the first through thirteenth aspects, the measurement information is first measurement information, selecting the one or more first antennas includes selecting, in accordance with the first antenna selection policy, the one or more first antennas based on second measurement information, and process 1000 includes selecting, based on the first measurement information, one or more third antennas, wherein the second antenna selection policy is based on a comparison of the one or more first antennas to the one or more third antennas.

In a fifteenth aspect, alone or in combination with one or more of the first through fourteenth aspects, the first measurement information includes uplink measurement information for each antenna of the one or more first antennas, and the second measurement information includes downlink measurement information.

In a sixteenth aspect, alone or in combination with one or more of the first through fifteenth aspects, the one or more first antennas are different than the one or more third antennas, and process 1000 includes determining the second antenna selection policy based on the one or more third antennas.

In a seventeenth aspect, alone or in combination with one or more of the first through sixteenth aspects, the feedback information is included in a periodic report, and process 1000 includes transmitting request information indicating to stop transmission of the periodic report or to reduce a periodicity of the periodic report, wherein the request information is based on convergence information of an AI/ML model associated with the first antenna selection policy and the second antenna selection policy.

In an eighteenth aspect, alone or in combination with one or more of the first through seventeenth aspects, the one or more first signals include one or more sounding reference signals.

In a nineteenth aspect, alone or in combination with one or more of the first through eighteenth aspects, the first performance level is based on at least one of an average transmission throughput, or measurement information.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a first network entity or an apparatus of a first network entity, in accordance with the present disclosure. Example process 1100 is an example where the apparatus or the first network entity (e.g., the first network entity 705, the network entity 102, the network entity 106, the network node 210, and/or the subject of action 510) performs operations associated with policy updates for antenna selection.

As shown in FIG. 11, in some aspects, process 1100 may include receiving one or more signals indicative of an antenna selection result associated with an antenna selection policy of a second network entity (block 1110). For example, the first network entity (e.g., using reception component 1302 and/or communication manager 1306, depicted in FIG. 13) may receive one or more signals indicative of an antenna selection result associated with an antenna selection policy of a second network entity, as described above.

As further shown in FIG. 11, in some aspects, process 1100 may include transmitting, based on the one or more signals, feedback information indicative of a first performance level of the antenna selection result (block 1120). For example, the first network entity (e.g., using transmission component 1304 and/or communication manager 1306, depicted in FIG. 13) may transmit, based on the one or more signals, feedback information indicative of a first performance level of the antenna selection result, as described above.

Process 1100 may include additional aspects, such as any single aspect or any combination of aspects described below and/or in connection with one or more other processes described elsewhere herein.

In a first aspect, the antenna selection policy is a policy for an AI/ML model that is configured to perform antenna selection.

In a second aspect, alone or in combination with the first aspect, the AI/ML model includes a neural network model.

In a third aspect, alone or in combination with one or more of the first and second aspects, the one or more signals are associated with respective antenna selection results of a set of antenna selection results including the antenna selection result, and process 1100 includes measuring the one or more signals to obtain measurement information associated with the set of antenna selection results, wherein the feedback information indicates one or more antenna selection results from the set of antenna selection results, and wherein the one or more antenna selection results are based on the measurement information.

In a fourth aspect, alone or in combination with one or more of the first through third aspects, process 1100 includes measuring the one or more signals to obtain measurement information associated with the antenna selection result, wherein the feedback information indicates whether the antenna selection result or a previous antenna selection result is associated with a higher performance level based on the measurement information.

In a fifth aspect, alone or in combination with one or more of the first through fourth aspects, the feedback information includes measurement information associated with the one or more signals.

In a sixth aspect, alone or in combination with one or more of the first through fifth aspects, transmitting the feedback information includes transmitting the feedback information to the second network entity.

In a seventh aspect, alone or in combination with one or more of the first through sixth aspects, the feedback information is included in a periodic report, and process 1100 includes receiving request information indicating to stop transmission of the periodic report or to reduce a periodicity of the periodic report.

In an eighth aspect, alone or in combination with one or more of the first through seventh aspects, receiving the request information includes receiving the request information from the second network entity.

In a ninth aspect, alone or in combination with one or more of the first through eighth aspects, the one or more signals include one or more sounding reference signals.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a network entity, or a network entity may include the apparatus 1200. In some aspects, the network entity may be a UE (e.g., the UE 220). In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 114, the communication manager 118, and/or the communication manager 250. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 110, the processing system 112, and/or the processing system 240).

In some aspects, the apparatus 1200 may be configured to perform one or more operations described herein in connection with FIGS. 7-9. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components described in connection with FIGS. 1-3. Additionally, or alternatively, one or more components shown in FIG. 12 may be implemented within one or more components described in connection with FIGS. 1-3. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components described above in connection with FIGS. 1-3, such as a radio, one or more RF chains, one or more transceivers, or one or more modems, each of which may in turn be coupled with one or more antennas of the network entity.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components described above in connection with FIGS. 1-3, such as a radio, one or more RF chains, one or more transceivers, or one or more modems, each of which may in turn be coupled with one or more antennas described in connection with FIGS. 1-3. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The communication manager 1206 may select, in accordance with a first antenna selection policy, one or more first antennas. The transmission component 1204 may transmit, using the one or more first antennas, one or more first signals. The reception component 1202 may obtain, based on the one or more first signals, feedback information indicative of a first performance level of the one or more first antennas. The communication manager 1206 may select, in accordance with a second antenna selection policy, one or more second antennas, wherein the second antenna selection policy is based on the feedback information. The transmission component 1204 may transmit, using the one or more second antennas, one or more second signals.

The communication manager 1206 may determine, based on the feedback information, performance level information indicative of whether the first performance level is greater than a second performance level associated with a previous antenna selection.

The communication manager 1206 may determine, based on the performance level information, the second antenna selection policy.

The communication manager 1206 may train, based on the feedback information, an AI/ML model to obtain the second antenna selection policy.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network entity, or a network entity may include the apparatus 1300. In some aspects, the network entity may be a network node (e.g., the network node 210). In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 114, the communication manager 118, and/or the communication manager 255. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 110, the processing system 112, and/or the processing system 245).

In some aspects, the apparatus 1300 may be configured to perform one or more operations described herein in connection with FIGS. 7-9. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components described in connection with FIGS. 1-3. Additionally, or alternatively, one or more components shown in FIG. 13 may be implemented within one or more components described in connection with FIGS. 1-3. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components described above in connection with FIGS. 1-3, such as a radio, one or more RF chains, one or more transceivers, or one or more modems, each of which may in turn be coupled with one or more antennas of the network entity.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components described above in connection with FIGS. 1-3, such as a radio, one or more RF chains, one or more transceivers, or one or more modems, each of which may in turn be coupled with one or more antennas described in connection with FIGS. 1-3. In some aspects, the transmission component 1304 may be co-located with the reception component 1302.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive one or more signals indicative of an antenna selection result associated with an antenna selection policy of a second network entity. The transmission component 1304 may transmit, based on the one or more signals, feedback information indicative of a first performance level of the antenna selection result.

The communication manager 1306 may measure the one or more signals to obtain measurement information associated with the antenna selection result, wherein the feedback information indicates whether the antenna selection result or a previous antenna selection result is associated with a higher performance level based on the measurement information.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a first network entity, comprising: selecting, in accordance with a first antenna selection policy, one or more first antennas; transmitting, using the one or more first antennas, one or more first signals; obtaining, based on the one or more first signals, feedback information indicative of a first performance level of the one or more first antennas; selecting, in accordance with a second antenna selection policy, one or more second antennas, wherein the second antenna selection policy is based on the feedback information; and transmitting, using the one or more second antennas, one or more second signals.

Aspect 2: The method of Aspect 1, wherein the first antenna selection policy and the second antenna selection policy are policies for an artificial intelligence or machine learning (AI/ML) model that is configured to perform antenna selection.

Aspect 3: The method of Aspect 2, wherein selecting the one or more first antennas comprises: providing, to the AI/ML model, measurement information; and obtaining, from the AI/ML model, an output that is indicative of the one or more first antennas, wherein the output is in accordance with the first antenna selection policy.

Aspect 4: The method of any of Aspects 2-3, wherein selecting the one or more second antennas comprises: providing, to the AI/ML model, measurement information; and obtaining, from the AI/ML model, an output that is indicative of the one or more second antennas, wherein the output is in accordance with the second antenna selection policy.

Aspect 5: The method of any of Aspects 2-4, wherein the AI/ML model includes a neural network model.

Aspect 6: The method of any of Aspects 1-5, further comprising: determining, based on the feedback information, performance level information indicative of whether the first performance level is greater than a second performance level associated with a previous antenna selection; and determining, based on the performance level information, the second antenna selection policy.

Aspect 7: The method of Aspect 6, wherein determining the second antenna selection policy comprises: determining, using a loss function, the second antenna selection policy based on the performance level information and the first antenna selection policy.

Aspect 8: The method of any of Aspects 1-7, further comprising: training, based on the feedback information, an artificial intelligence or machine learning (AI/ML) model to obtain the second antenna selection policy.

Aspect 9: The method of any of Aspects 1-8, wherein the feedback information includes an average transmission throughput associated with the one or more first antennas.

Aspect 10: The method of any of Aspects 1-9, wherein obtaining the feedback information comprises: receiving the feedback information.

Aspect 11: The method of Aspect 10, wherein receiving the feedback information comprises: receiving the feedback information from a second network entity.

Aspect 12: The method of any of Aspects 10-11, wherein the feedback information includes one or more antenna selection results from a set of antenna selection results, wherein the one or more antenna selection results are associated with one or more highest performance levels, wherein the one or more first antennas are associated with an antenna selection result from the set of antenna selection results.

Aspect 13: The method of any of Aspects 10-12, wherein the feedback information indicates whether the first performance level is greater than a second performance level associated with a previously performed antenna selection operation.

Aspect 14: The method of any of Aspects 10-13, wherein the feedback information includes measurement information associated with the one or more first signals, wherein the first performance level is based on the measurement information.

Aspect 15: The method of Aspect 14, wherein the measurement information is first measurement information, and wherein selecting the one or more first antennas comprises: selecting, in accordance with the first antenna selection policy, the one or more first antennas based on second measurement information, and the method further comprises: selecting, based on the first measurement information, one or more third antennas, wherein the second antenna selection policy is based on a comparison of the one or more first antennas to the one or more third antennas.

Aspect 16: The method of Aspect 15, wherein the first measurement information includes uplink measurement information for each antenna of the one or more first antennas, and wherein the second measurement information includes downlink measurement information.

Aspect 17: The method of any of Aspects 15-16, wherein the one or more first antennas are different than the one or more third antennas, and the method further comprises: determining the second antenna selection policy based on the one or more third antennas.

Aspect 18: The method of any of Aspects 10-17, wherein the feedback information is included in a periodic report, and the method further comprises: transmitting request information indicating to stop transmission of the periodic report or to reduce a periodicity of the periodic report, wherein the request information is based on convergence information of an artificial intelligence or machine learning (AI/ML) model associated with the first antenna selection policy and the second antenna selection policy.

Aspect 19: The method of any of Aspects 1-18, wherein the one or more first signals include one or more sounding reference signals.

Aspect 20: The method of any of Aspects 1-19, wherein the first performance level is based on at least one of: an average transmission throughput, or measurement information.

Aspect 21: A method of wireless communication performed by a first network entity, comprising: receiving one or more signals indicative of an antenna selection result associated with an antenna selection policy of a second network entity; and transmitting, based on the one or more signals, feedback information indicative of a first performance level of the antenna selection result.

Aspect 22: The method of Aspect 21, wherein the antenna selection policy is a policy for an artificial intelligence or machine learning (AI/ML) model that is configured to perform antenna selection.

Aspect 23: The method of Aspect 22, wherein the AI/ML model includes a neural network model.

Aspect 24: The method of any of Aspects 21-23, wherein the one or more signals are associated with respective antenna selection results of a set of antenna selection results including the antenna selection result, and the method further comprises: measuring the one or more signals to obtain measurement information associated with the set of antenna selection results, wherein the feedback information indicates one or more antenna selection results from the set of antenna selection results, and wherein the one or more antenna selection results are based on the measurement information.

Aspect 25: The method of any of Aspects 21-24, further comprising: measuring the one or more signals to obtain measurement information associated with the antenna selection result, wherein the feedback information indicates whether the antenna selection result or a previous antenna selection result is associated with a higher performance level based on the measurement information.

Aspect 26: The method of any of Aspects 21-25, wherein the feedback information includes measurement information associated with the one or more signals.

Aspect 27: The method of any of Aspects 21-26, wherein transmitting the feedback information comprises: transmitting the feedback information to the second network entity.

Aspect 28: The method of any of Aspects 21-27, wherein the feedback information is included in a periodic report, and the method further comprises: receiving request information indicating to stop transmission of the periodic report or to reduce a periodicity of the periodic report.

Aspect 29: The method of Aspect 28, wherein receiving the request information comprises: receiving the request information from the second network entity.

Aspect 30: The method of any of Aspects 21-29, wherein the one or more signals include one or more sounding reference signals.

Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.

Aspect 32: An apparatus for wireless communication at a device, the apparatus comprising one or more memories and one or more processors coupled to the one or more memories, the one or more processors configured to cause the device to perform the method of one or more of Aspects 1-30.

Aspect 33: An apparatus for wireless communication, the apparatus comprising at least one means for performing the method of one or more of Aspects 1-30.

Aspect 34: A non-transitory computer-readable medium storing code for wireless communication, the code comprising instructions executable by one or more processors to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

Aspect 36: A device for wireless communication, the device comprising a processing system that includes one or more processors and one or more memories coupled with the one or more processors, the processing system configured to cause the device to perform the method of one or more of Aspects 1-30.

Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.

Aspect 38: A device for wireless communication, the device comprising a processing system, the processing system configured to perform the method of one or more of Aspects 1-30.

Aspect 39: A non-transitory computer-readable medium having code stored thereon that, when executed by a device, causes the device to perform the method of one or more of Aspects 1-30.

The foregoing disclosure provides illustration and description but is neither exhaustive nor limiting of the scope of this disclosure. For example, various aspects and examples are disclosed herein, but this disclosure is not limited to the precise form in which such aspects and examples are described. Modifications and variations may be made in light of the above disclosure or may be acquired from practice of the aspects.

As used herein, the term “component” shall be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. Systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and/or measuring, among other examples. Also, “determining” can include receiving (such as receiving information), accessing (such as accessing data stored in memory), and/or transmitting (such as transmitting information), among other examples. As another example, “determining” can include resolving, selecting, obtaining, choosing, establishing, and/or other such similar actions.

Even though particular combinations of features are recited in the claims and/or disclosed in the specification, these combinations do not limit the scope of the disclosure. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As used herein, a phrase referring to “at least one of” a list of items refers to any combination of those items, including single members. As an example, “at least one of: a, b, or c” covers a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” include one or more items and may be used interchangeably with “one or more.” Further, as used herein, the article “the” may include one or more items referenced in connection with the article “the” and may be used interchangeably with “the one or more.” Furthermore, as used herein, the terms “set” and “group” may include one or more items and may be used interchangeably with “one or more.” Where only one item is intended, the phrase “only one” or similar language is used. Also, as used herein, the terms “has,” “have,” “having,” and similar terms are open-ended terms that do not limit an element that they modify (for example, an element “having” A may also have B). Further, the phrase “based on” means “based on or otherwise in association with” unless explicitly stated otherwise. Additionally, as used herein, the phrase “based on” shall not be construed as a reference to a closed set of information, one or more conditions, one or more factors, or the like. Also, as used herein, the term “or” is inclusive when used in a series and may be used interchangeably with “and/or,” unless explicitly stated otherwise (for example, if used in combination with “either” or “only one of”). Further, “one or more” may be equivalent to “at least one.”

Even though particular combinations of features are recited in the claims or disclosed in the specification, these combinations are not limiting of the disclosure of various aspects. Many of these features may be combined in ways not specifically recited in the claims or disclosed in the specification. The disclosure of various aspects includes each dependent claim in combination with every other claim in the claim set.

What is claimed is:

1. A first network entity, comprising:
a processing system configured to:
select, in accordance with a first antenna selection policy, one or more first antennas;
transmit, using the one or more first antennas, one or more first signals;
obtain, based on the one or more first signals, feedback information indicative of a first performance level of the one or more first antennas;
select, in accordance with a second antenna selection policy, one or more second antennas, wherein the second antenna selection policy is based on the feedback information; and
transmit, using the one or more second antennas, one or more second signals.

2. The first network entity of claim 1, wherein the first antenna selection policy and the second antenna selection policy are policies for an artificial intelligence or machine learning (AI/ML) model that is configured to perform antenna selection.

3. The first network entity of claim 2, wherein, to select the one or more first antennas, the processing system is configured to:
provide, to the AI/ML model, measurement information; and
obtain, from the AI/ML model, an output that is indicative of the one or more first antennas, wherein the output is in accordance with the first antenna selection policy.

4. The first network entity of claim 2, wherein, to select the one or more second antennas, the processing system is configured to:
provide, to the AI/ML model, measurement information; and
obtain, from the AI/ML model, an output that is indicative of the one or more second antennas, wherein the output is in accordance with the second antenna selection policy.

5. The first network entity of claim 1, wherein the processing system is configured to:
determine, based on the feedback information, performance level information indicative of whether the first performance level is greater than a second performance level associated with a previous antenna selection; and
determine, based on the performance level information, the second antenna selection policy.

6. The first network entity of claim 5, wherein, to determine the second antenna selection policy, the processing system is configured to:
determine, using a loss function, the second antenna selection policy based on the performance level information and the first antenna selection policy.

7. The first network entity of claim 1, wherein the feedback information includes an average transmission throughput associated with the one or more first antennas.

8. The first network entity of claim 1, wherein, to obtain the feedback information, the processing system is configured to:
receive the feedback information.

9. The first network entity of claim 8, wherein the feedback information includes one or more antenna selection results from a set of antenna selection results, wherein the one or more antenna selection results are associated with one or more highest performance levels, wherein the one or more first antennas are associated with an antenna selection result from the set of antenna selection results.

10. The first network entity of claim 8, wherein the feedback information indicates whether the first performance level is greater than a second performance level associated with a previously performed antenna selection operation.

11. The first network entity of claim 8, wherein the feedback information includes measurement information associated with the one or more first signals, wherein the first performance level is based on the measurement information.

12. The first network entity of claim 11, wherein the measurement information is first measurement information, and wherein, to select the one or more first antennas, the processing system is configured to:
select, in accordance with the first antenna selection policy, the one or more first antennas based on second measurement information, and wherein the processing system is configured to:
select, based on the first measurement information, one or more third antennas, wherein the second antenna selection policy is based on a comparison of the one or more first antennas to the one or more third antennas.

13. The first network entity of claim 12, wherein the first measurement information includes uplink measurement information for each antenna of the one or more first antennas, and wherein the second measurement information includes downlink measurement information.

14. The first network entity of claim 12, wherein the one or more first antennas are different than the one or more third antennas, and wherein the processing system is configured to:
determine the second antenna selection policy based on the one or more third antennas.

15. The first network entity of claim 8, wherein the feedback information is included in a periodic report, and wherein the processing system is configured to:
transmit request information indicating to stop transmission of the periodic report or to reduce a periodicity of the periodic report, wherein the request information is based on convergence information of an artificial intelligence or machine learning (AI/ML) model associated with the first antenna selection policy and the second antenna selection policy.

16. A first network entity, comprising:
a processing system configured to:
receive one or more signals indicative of an antenna selection result associated with an antenna selection policy of a second network entity; and
transmit, based on the one or more signals, feedback information indicative of a first performance level of the antenna selection result.

17. The first network entity of claim 16, wherein the antenna selection policy is a policy for an artificial intelligence or machine learning (AI/ML) model that is configured to perform antenna selection.

18. The first network entity of claim 16, wherein the one or more signals are associated with respective antenna selection results of a set of antenna selection results including the antenna selection result, and wherein the processing system is configured to:
measure the one or more signals to obtain measurement information associated with the set of antenna selection results, wherein the feedback information indicates one or more antenna selection results from the set of antenna selection results, and wherein the one or more antenna selection results are based on the measurement information.

19. The first network entity of claim 16, wherein the processing system is configured to:
measure the one or more signals to obtain measurement information associated with the antenna selection result, wherein the feedback information indicates whether the antenna selection result or a previous antenna selection result is associated with a higher performance level based on the measurement information.

20. The first network entity of claim 16, wherein the feedback information includes measurement information associated with the one or more signals.

21. The first network entity of claim 16, wherein, to transmit the feedback information, the processing system is configured to transmit the feedback information to the second network entity.

22. The first network entity of claim 16, wherein the feedback information is included in a periodic report, and wherein the processing system is configured to:
receive request information indicating to stop transmission of the periodic report or to reduce a periodicity of the periodic report.

23. A method of wireless communication performed by a first network entity, comprising:
selecting, in accordance with a first antenna selection policy, one or more first antennas;
transmitting, using the one or more first antennas, one or more first signals;
obtaining, based on the one or more first signals, feedback information indicative of a first performance level of the one or more first antennas;
selecting, in accordance with a second antenna selection policy, one or more second antennas, wherein the second antenna selection policy is based on the feedback information; and
transmitting, using the one or more second antennas, one or more second signals.

24. The method of claim 23, wherein the first antenna selection policy is for an artificial intelligence or machine learning (AI/ML) model, and wherein selecting the one or more first antennas comprises:
providing, to the AI/ML model, measurement information; and
obtaining, from the AI/ML model, an output that is indicative of the one or more first antennas, wherein the output is in accordance with the first antenna selection policy.

25. The method of claim 23, wherein the second antenna selection policy is for an artificial intelligence or machine learning (AI/ML) model, and wherein selecting the one or more second antennas comprises:
providing, to the AI/ML model, measurement information; and
obtaining, from the AI/ML model, an output that is indicative of the one or more second antennas, wherein the output is in accordance with the second antenna selection policy.

26. The method of claim 23, further comprising:
determining, based on the feedback information, performance level information indicative of whether the first performance level is greater than a second performance level associated with a previous antenna selection; and
determining, based on the performance level information, the second antenna selection policy.

27. The method of claim 26, wherein determining the second antenna selection policy comprises:
determining, using a loss function, the second antenna selection policy based on the performance level information and the first antenna selection policy.

28. A method of wireless communication performed by a first network entity, comprising:
receiving one or more signals indicative of an antenna selection result associated with an antenna selection policy of a second network entity; and
transmitting, based on the one or more signals, feedback information indicative of a first performance level of the antenna selection result.

29. The method of claim 28, wherein the one or more signals are associated with respective antenna selection results of a set of antenna selection results including the antenna selection result, and the method further comprises:
measuring the one or more signals to obtain measurement information associated with the set of antenna selection results, wherein the feedback information indicates one or more antenna selection results from the set of antenna selection results, and wherein the one or more antenna selection results are based on the measurement information.

30. The method of claim 28, further comprising:
measuring the one or more signals to obtain measurement information associated with the antenna selection result, wherein the feedback information indicates whether the antenna selection result or a previous antenna selection result is associated with a higher performance level based on the measurement information.
